(19) United States
(12) Patent Application Publication
(10) Pub. No.: US 2014/0015310 A1
(43) Pub. Date: Jan. 16, 2014

(54) PARKING BRAKE CONTROL DEVICE

(71) Applicants: Masatoshi Hanzawa, Kariya-city (JP); Kazuma Kondo, Kariya-city (JP)

(72) Inventors: Masatoshi Hanzawa, Kariya-city (JP); Kazuma Kondo, Kariya-city (JP)

(73) Assignee: ADVICS CO ., LTD., Kariya-city (JP)

(21) Appl. No.: 14/007,419

(22) PCT Filed: Sep. 26, 2012
(86) PCT No.: PCT/JP2012/074737

§ 371 Date: Sep. 25, 2013

(30) Foreign Application Priority Data
Sep. 27, 2011 (JP) 2011-210643

(51) Int. Cl. B60T 13/58

(52) U.S. Cl. CPC B60T 13/58
USPC 303/3

(57) ABSTRACT

When an abnormality is occurring in a main braking device for service brake, a parking brake control device determines whether the abnormality is a single system failure or a dual system failure and whether to execute an auxiliary lock control that generates a parking brake force by controlling a parking brake device. The parking brake control device then sets, in accordance with a mode of failure determined, a wheel on which the auxiliary lock control is to be executed.

### TECHNICAL FIELD

The present invention relates to a parking brake control device that is applied to a vehicle brake system having a service brake and an electric parking brake (hereinafter referred to as an EPB).

### BACKGROUND ART

In related art, Patent Literature 1 proposes a parking brake control device that performs control when a service brake fails while a vehicle is traveling, by activating an EPB through switch operation of the EPB and thereby generating a brake force in order to obtain a desired deceleration. In this case, a reaction time of the EPB is higher or slower based on the operation time of the switch. Further, Patent Literature 2 proposes a parking brake control device in which, at a time of a brake failure of a service brake, the EPB is used to generate a brake force such that a predetermined deceleration is obtained.

### CITATION LIST

### Patent Literature

[PTL 1]

Japanese Patent Application Publication No. JP-A-2005-162013

[PTL 2]

Japanese Patent Application Publication No. JP-A-2005-343248

### SUMMARY OF INVENTION

### Technical Problem

However, if a prerequisite of activating the EPB is the operation of an operation switch of the EPB, as described in Patent Literature 1, in an emergency, there is a possibility that the EPB is not appropriately activated, as it may be difficult to operate the operation switch or there may be a delay in operating the operation switch. Further, in Patent Literature 2, although it is disclosed that the brake force is generated by the EPB at a time of a brake failure, a method of activation is not specifically disclosed.

In light of the foregoing, it is an object of the present invention to provide a parking brake control device that appropriately generates a desired brake force by activating an EPB at a time of an abnormality, such as a brake failure.

### Solution to Problem

In order to achieve the above-described object, the invention described in a first aspect is characterized by including: auxiliary control means for executing auxiliary control in which auxiliary lock control that controls a parking brake device and generates a parking brake force and auxiliary release control that releases the parking brake force are performed, and thus a target brake force in accordance with an operation amount of a brake operating member is generated using a brake force generated by a main braking device and the parking brake force. The auxiliary control means includes: abnormality determination means for determining whether an abnormality is occurring in the main braking device; auxiliary lock determination means for determining, when an abnormality is determined by the abnormality determination means, whether the abnormality is a single system failure in which one system of the two systems has failed or a dual system failure in which both systems of the two systems have failed, and for determining whether to execute the auxiliary lock control that generates the parking brake force by controlling the parking brake device; auxiliary release determination means for determining, after the auxiliary lock control, whether to execute the auxiliary release control that releases the parking brake force generated by the auxiliary lock control; auxiliary lock control processing means for setting, in accordance with a mode of failure determined by the auxiliary lock determination means, a wheel on which the auxiliary lock control is to be executed and the parking brake force to be generated by the auxiliary lock control; and auxiliary release control processing means for executing the auxiliary release control that releases the parking brake force generated by the auxiliary lock control, based on the determination of the auxiliary release determination means.

In this manner, even when there is an abnormality in the main braking device, the auxiliary lock control is performed that generates the lacking brake force based on a lock operation of the parking brake device, or the auxiliary release control is performed that causes a release operation of the parking brake device when the brake force generated by the parking brake device is released. Then, depending on the mode of the failure determined by the auxiliary lock determination means, the wheel on which the auxiliary lock control is to be performed and the parking brake force to be generated by the auxiliary lock control are set. Thus, even when there is an abnormality in the main braking device, it is possible to appropriately generate a desired brake force.

The invention described in a second aspect is characterized in that, when the failure determined by the auxiliary lock determination means is the single system failure, the auxiliary lock control processing means sets the parking brake force to be generated only by the parking brake device provided on a wheel of the system on which the failure is detected. When the failure determined by the auxiliary lock determination means is the dual system failure, the auxiliary lock control processing means sets the parking brake force to be generated by the parking brake device provided on wheels of both systems.

In this manner, the parking brake force is generated by the parking brake device provided on the wheel on which the failure is detected, and the lacking brake force is thus compensated for the wheel of the system that has failed. It is thus possible to cause the brake force to act in a direction to suppress the occurrence of yaw. In this manner, it is possible to perform braking while more reliably maintaining the stability of the vehicle.

For example, as described in a third aspect, the auxiliary lock determination means can determine the single system failure and the dual system failure by determining whether one of a relationship between a stroke amount and an operating force of the brake operating member and a relationship between a master cylinder pressure and a deceleration of the vehicle is outside a predetermined range that is established based on a relationship assumed in normal operation in which the single system failure has not occurred, or whether the one of the relationships is outside a predetermined range that is established based on a relationship assumed in normal operation in which the dual system failure has not occurred.

For example, as described in a fourth aspect, the auxiliary release determination means can determine that the auxiliary release control is to be executed when one of the relationship between the stroke amount and the operating force of the brake operating member and the relationship between the master cylinder pressure and the deceleration of the vehicle is within the predetermined range established based on the relationship assumed in normal operation in which the single system failure has not occurred, or when the one of the relationships is within the predetermined range that is established based on the relationship assumed in normal operation in which the dual system failure has not occurred.

The invention described in a fifth aspect is characterized in that the abnormality determination means determines, as one of the abnormalities, whether or not an engine negative pressure that is used by a booster drops and is in a negative pressure drop state. When it is determined by the abnormality determination means that a negative pressure drop state exists, the auxiliary lock determination means determines that the auxiliary lock control is to be executed when the master cylinder pressure is within a range between a predetermined lock threshold lower limit and a lock threshold upper limit, and a differential value of the master cylinder pressure is within a range between a predetermined lock differential threshold lower limit and a lock differential threshold upper limit.

In this manner, even in a negative pressure drop state, the auxiliary lock control is performed that generates the lacking brake force based on the lock operation of the parking brake device, or the auxiliary release control is performed that causes the release operation of the parking brake device when the brake force generated by the parking brake device is released. Thus, even in a negative pressure drop state, it is possible to appropriately generate the desired brake force.

In this case, as described in a sixth aspect, the auxiliary release determination means can determine that the auxiliary release control is to be executed when the master cylinder pressure is lower than the predetermined lock threshold lower limit or higher than the lock threshold upper limit, and the differential value of the master cylinder is lower than the predetermined lock differential threshold lower limit or higher than the lock differential threshold upper limit.

Note that the reference numeral in brackets of each means described above shows an example of a corresponding relationship with specific means explained in embodiments described later.

### BRIEF DESCRIPTION OF DRAWINGS

[FIG. 1]

FIG. 1 is a schematic diagram showing an overall outline of a vehicle brake system to which a parking brake control device according to a first embodiment of the present invention is applied.

[FIG. 2]

FIG. 2 is a cross-sectional schematic diagram of a rear wheel brake mechanism that is provided in the brake system.

[FIG. 3]

FIG. 3 is a flowchart showing, in detail, parking brake control processing.

[FIG. 4]

FIG. 4 is a flowchart showing, in detail, EPB auxiliary control determination.

[FIG. 5]

FIG. 5 is a flowchart showing, in detail, auxiliary lock determination processing.

[FIG. 6]

FIG. 6 is a flowchart showing, in detail, auxiliary release determination processing.

[FIG. 7]

FIG. 7 is a map showing an example of an assumed relationship between a stroke amount and a pedal depression force at a time of a single system failure in a main braking device.

[FIG. 8]

FIG. 8 is a map showing an example of an assumed relationship between an M/C pressure and a deceleration [G] at a time of a single system failure in the main braking device.

[FIG. 9]

FIG. 9 is a map showing an example of an assumed relationship between the stroke amount and the pedal depression force at a time of a dual system failure in the main braking device.

[FIG. 10]

FIG. 10 is a map showing an example of an assumed relationship between the M/C pressure and the deceleration [G] at a time of a dual system failure in the main braking device.

[FIG. 11]

FIG. 11 is a map showing an example of an assumed relationship between the stroke amount and the pedal depression force when the main braking device is operating normally.

[FIG. 12]

FIG. 12 is a map showing an assumed relationship between the M/C pressure and the deceleration [G] when the main braking device is operating normally.

[FIG. 13]

FIG. 13 is a flowchart showing, in detail, auxiliary lock control processing.

[FIG. 14]

FIG. 14 is a map showing a relationship between an M/C pressure (MPa) and a target deceleration [G].

[FIG. 15]

FIG. 15 is a map showing a relationship between the M/C pressure (MPa) and a target current value [A] at a time of a negative pressure drop state.

[FIG. 16]

FIG. 16 is a flowchart showing, in detail, auxiliary release control processing.

[FIG. 17]

FIG. 17 is a flowchart showing, in detail, lock control processing.

[FIG. 18]

FIG. 18 is a map showing a relationship of a target motor current value increase amount in correspondence to a target brake force.

[FIG. 19]

FIG. 19 is a map showing a relationship of a target motor current value increase amount subtraction value in correspondence to the M/C pressure.

[FIG. 20]

FIG. 20 is a flowchart showing, in detail, release control processing.

[FIG. 21]

FIG. 21 is a flowchart showing, in detail, lock/release display processing.

[FIG. 22]

FIG. 22 is a timing chart illustrating processing at a time of a brake failure.

[FIG. 23]

FIG. 23 is a timing chart of a case in which the deceleration [G] is not obtained based on the stroke corresponding to the M/C pressure, as processing at a time of a brake failure.

[FIG. 24]

FIG. 24 is a timing chart of a case in which the stroke is obtained with respect to the pedal depression force, as processing at a time of a brake failure.

[FIG. 25]

FIG. 25 is a timing chart illustrating a response at a time of a negative pressure drop state.

[FIG. 26]

FIG. 26 is a timing chart of a case in which EPB auxiliary control is performed at a time of a negative pressure drop state.

[FIG. 27]

FIG. 27 is a timing chart of a case in which the EPB auxiliary control is performed at a time of a negative pressure drop state.

### DESCRIPTION OF EMBODIMENTS

Hereinafter, embodiments of the present invention will be explained with reference to the drawings. Note that, in the respective embodiments below, portions that are the same or equivalent to each other are assigned the same reference numerals in the drawings.

### First Embodiment

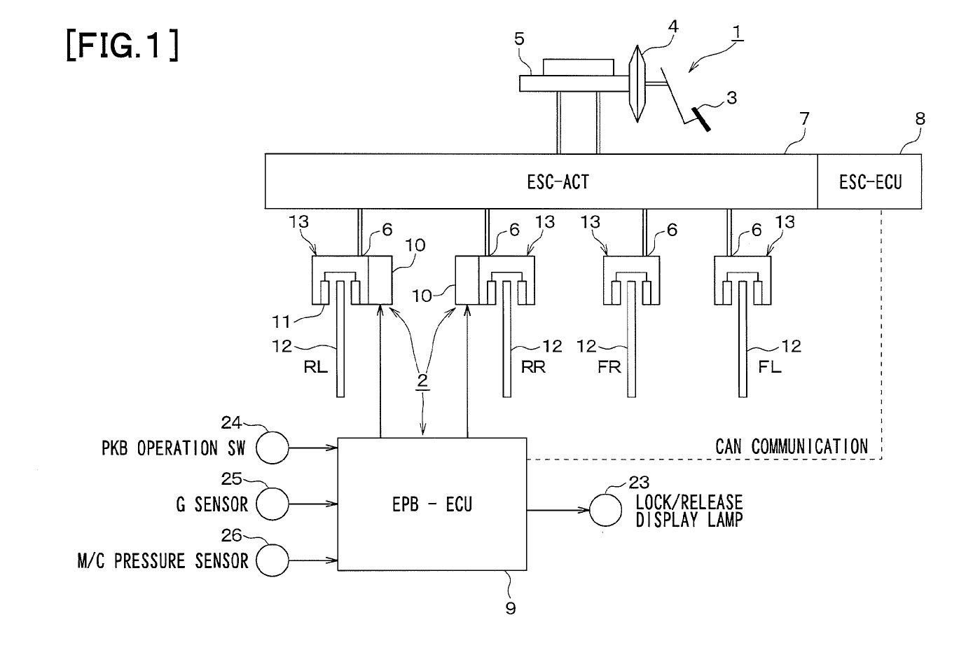

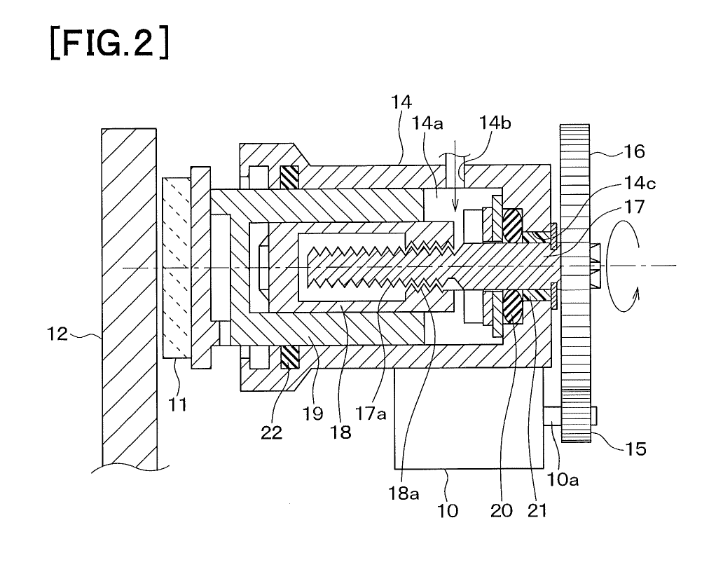

A first embodiment of the present invention will be explained. In the present embodiment, a vehicle brake system in which a disc brake type EPB is applied to a rear wheel system will be explained as an example. FIG. 1 is a schematic diagram showing an overall outline of the vehicle brake system to which a parking brake control device according to the present embodiment is applied. FIG. 2 is a cross-sectional schematic diagram of a rear wheel brake mechanism that is provided in the brake system. These figures will be referred to in the following explanation.

As shown in FIG. 1, the brake system is provided with a service brake 1 that generates a brake force based on a pedal depression force by a driver, and an EPB 2 that restricts movement of a vehicle at the time of parking.

The service brake 1 boosts the pedal depression force that corresponds to depression of a brake pedal 3 by the driver, using a booster 4. After that, a brake fluid pressure corresponding to the boosted pedal depression force is generated in a master cylinder (hereinafter referred to as an M/C) 5, and the brake fluid pressure is transmitted to a wheel cylinder (hereinafter referred to as a W/C) 6 that is provided in a brake mechanism of each wheel, thereby generating the brake force. The booster 4 boosts the pedal depression force based on an engine negative pressure, and an M/C piston is pressed by the generated force via a push rod, thus generating an M/C pressure. Further, an actuator 7 for brake fluid pressure control is provided between the M/C 5 and the W/C 6, and the brake force generated by the service brake 1 is adjusted, thereby achieving a structure in which various types of control (for example, anti-skid control etc) can be performed to improve vehicle safety. In the present specification, a device that includes the service brake 1 and the actuator 7 and that mainly generates a brake force based on a brake operation by a driver is referred to as a main braking device.

The various types of control using the actuator 7 are performed by an electronic stability control (ESC)-ECU 8. For example, the ESC-ECU 8 outputs a control current for controlling various types of control valves and a pump drive motor that are not shown in the drawings and that are provided in the actuator 7. The ESC-ECU 8 thereby controls a hydraulic circuit provided in the actuator 7, and controls a W/C pressure that is transmitted to the W/C 6. As a result, wheel slip is avoided and the safety of the vehicle is improved. For example, the actuator 7 includes, for each wheel, a pressure increase control valve and a pressure decrease control valve etc., and the W/C pressure can be controlled to be increased, maintained or reduced. The pressure increase control valve controls application to the W/C 6 of either the brake fluid pressure generated in the M/C 5 or the brake fluid pressure generated by pump drive. The pressure decrease control valve reduces the W/C pressure by supplying the brake fluid in each of the W/Cs 6 to a reservoir. The structure of the actuator 7 is a known structure, and a detailed explanation thereof is therefore omitted here.

Meanwhile, the EPB 2 generates a brake force by controlling the brake mechanisms using motors 10. The EPB 2 is configured such that it includes an EPB control device (hereinafter referred to as an EPB-ECU) 9 that controls the driving of the motors 10.

Each brake mechanism is a mechanical structure that generates a brake force in the brake system of the present embodiment. Each front wheel brake mechanism is a structure that generates a brake force by an operation of the service brake 1. Meanwhile, each rear wheel brake mechanism is a dual-operation structure that generates a brake force in response to both the operation of the service brake 1 and the operation of the EPB 2. Each front wheel brake mechanism is a generally used known brake mechanism, and does not include the mechanism that generates a brake force based on the operation of the EPB 2, unlike the rear wheel brake mechanisms. Therefore, an explanation thereof is omitted here, and the rear wheel brake mechanisms will be explained below.

Not only when the service brake 1 is actuated but also when the EPB 2 is actuated, each of the rear wheel brake mechanisms presses a brake pad 11, which is a friction-applying member shown in FIG. 2, and a brake disc 12, which is a friction-applied member, is sandwiched by the brake pads 11. Thus, a frictional force is generated between the brake pads 11 and the brake disc 12 and the brake force is generated.

Each pressurizing mechanism of the EPB 2 includes a motor 10, a spur gear 15, a spur gear 16, a rotation shaft 17 and a propeller shaft 18. This pressurizing mechanism generates the parking brake force. Specifically, in a caliper 13 shown in FIG. 1, each brake mechanism rotates the motor 10 that is directly fixed to a body 14 of the W/C 6 for pressing the brake pads 11, as shown in FIG. 2, and thereby rotates the spur gear 15 that is provided on a drive shaft 10a of the motor 10. Then, each brake mechanism transmits the torque of the motor 10 to the spur gear 16 that is meshed with the spur gear 15, and thereby moves the brake pads 11. Thus, the brake force of the EPB 2 is generated.

In the caliper 13, in addition to the W/C 6 and the brake pads 11, a part of an end face of the brake disc 12 is housed such that it is sandwiched between the brake pads 11. The W/C 6 is configured such that when brake fluid pressure is supplied to a hollow section 14a of a cylinder shaped body 14 through a passage 14b, W/C pressure is generated inside the hollow section 14a that is a brake fluid chamber. The W/C 6 is configured to include, in the hollow section 14a, the rotation shaft 17, the propeller shaft 18, a piston 19 and so on. The body 14 has a bottomed cylindrical shape and the body 14 is disposed such that the bottom surface of the body 14 is on the opposite side to the brake pad 11 and an opening of the body 14 is on the side of the brake pad 11. The piston 19 blocks the opening of the body 14.

An end of the rotation shaft 17 is connected to the spur gear 16 through an insertion hole 14c that is formed in the body 14. When the spur gear 16 is rotated, the rotation shaft 17 is rotated along with the rotation of the spur gear 16. A male screw groove 17a is formed in an outer peripheral surface of the rotation shaft 17 at an end of the rotation shaft 17 that is on the opposite side to the end connected to the spur gear 16. Further, the other end of the rotation shaft 17 is inserted into the insertion hole 14c, and is thereby supported axially. More specifically, the insertion hole 14c is provided with an O-ring 20 and a bearing 21. The O-ring 20 prevents the brake fluid from leaking through between the rotation shaft 17 and an inner wall surface of the insertion hole 14c, while the bearing 21 axially supports the other end of the rotation shaft 17.

The propeller shaft 18 is a hollow tubular member, and a female screw groove 18a that engages with the male screw groove 17a of the rotation shaft 17 is formed in an inner wall surface of the propeller shaft 18. For example, the propeller shaft 18 has a column shape and is provided with an anti-rotation key, or has a polygonal column shape, so that the propeller shaft 18 does not rotate around the rotation center of the rotation shaft 17 even when the rotation shaft 17 rotates. Therefore, when the rotation shaft 17 is rotated, the meshing between the male screw groove 17a and the female screw groove 18a converts the torque of the rotation shaft 17 to a force that moves the propeller shaft 18 in the axial direction of the rotation shaft 17. When the drive of the motor 10 is stopped, the propeller shaft 18 stops at a same position due to the frictional force generated by the meshing between the male screw groove 17a and the female screw groove 18a. If the drive of the motor 10 is stopped when a target brake force is reached, the propeller shaft 18 can be held in that position.

The piston 19 is arranged to surround an outer periphery of the propeller shaft 18, and is formed by a bottomed cylindrical member or a bottomed polygonal cylindrical member. An outer peripheral surface of the piston 19 abuts against an inner wall surface of the hollow section 14a formed in the body 14. In order to inhibit leakage of the brake fluid from between the outer peripheral surface of the piston 19 and an inner wall surface of the body 14, a seal member 22 is provided on the inner wall surface of the body 14. Thus, the W/C pressure can be applied to an end face of the piston 19. Further, when the propeller shaft 18 is provided with the anti-rotation key in order to ensure that it does not rotate about the rotation center of the rotation shaft 17 when the rotation shaft 17 rotates, the piston 19 is provided with a key groove along which the anti-rotation key slidingly moves. If the propeller shaft 18 has a polygonal column shape, the piston 19 is formed in a polygonal cylinder shape that corresponds to that shape.

The brake pad 11 is provided at an end of the piston 19, and the brake pad 11 is moved in the left-right direction in the drawing along with the movement of the piston 19. More specifically, the piston 19 is configured such that it can move in the left direction in the drawing along with the movement of the propeller shaft 18, the outer peripheral surface of the piston 19 being in contact with the inner wall surface of the hollow section 14a of the body 14, and such that it can also move in the left direction in the drawing independently of the propeller shaft 18 when the W/C pressure is applied to an end of the piston 19 (an end that is on the opposite side to the end provided with the brake pad 11). If the brake fluid pressure in the hollow section 14a is not applied (W/C pressure=0) when the propeller shaft 18 is in an initial position (a state before the motor 10 is rotated), the piston 19 is moved in the right direction in the drawing by a return spring that is not shown in the drawings, or by the negative pressure inside the hollow section 14a. The brake pad 11 is thereby moved away from the brake disc 12. If the W/C pressure becomes zero when the motor 10 is rotated and the propeller shaft 18 is moved from the initial position to the left in the drawing, the movement of the piston 19 in the right direction in the drawing is restricted by the moved propeller shaft 18, and the brake pad 11 is held at that position.

In each of the brake mechanisms structured as described above, when the service brake 1 is operated, the W/C pressure generated by the operation of the service brake 1 causes the piston 19 to move in the left direction in the drawing. As a result, the brake pads 11 are pressed against the brake disc 12, and the brake force is thereby generated. Further, when the EPB 2 is operated, the motor 10 is driven and the spur gear 15 is rotated. Along with this, the spur gear 16 and the rotation shaft 17 are rotated, and the meshing between the male screw groove 17a and the female screw 18a causes the propeller shaft 18 to move to the brake disc 12 side (in the left direction in the drawing). Then, along with this, the piston 19 is also moved in the same direction, the brake pads 11 are pressed against the brake disc 12, and the brake force is thereby generated. Thus, it is possible to achieve a dual-operation brake mechanism that generates a brake force in response to both the operation of the service brake 1 and the operation of the EPB 2.

Further, if the EPB 2 is operated in a state in which the W/C pressure is being generated by an actuation of the service brake 1, as the piston 19 has already moved to the left direction in the drawing as a result of the W/C pressure, the load on the propeller shaft 18 is reduced. For that reason, the motor 10 is driven with almost no load until the propeller shaft 18 comes into contact with the piston 19. Then, when the propeller shaft 18 comes into contact with the piston 19, the pressing force by which the piston 19 is being caused to move to the left direction in the drawing is applied, and the brake force is generated by the EPB 2.

The EPB-ECU 9 is configured by a well-known microcomputer that is provided with a CPU, a ROM, a RAM, an I/O and the like, and performs parking brake control by controlling the rotation of the motors 10 in accordance with a program stored in the ROM or the like. The EPB-ECU 9 corresponds to a parking brake control device of the present invention. The EPB-ECU 9 receives a signal etc. in accordance with an operation state of an operation switch (SW) 24 that is provided on an instrument panel (not shown in the drawings) in a vehicle compartment, for example, or receives a detection signal of a G sensor 25, which detects an acceleration of the vehicle in the forward and rearward directions, and a detection signal of an M/C pressure sensor 26. The EPB-ECU 9 drives the motors 10 in accordance with the operation state of the operation SW 24, a G sensor value in the forward/rearward direction of the vehicle and the M/C pressure. Further, in accordance with a drive state of the motors 10, the EPB-ECU 9 outputs a signal indicating whether the wheel is in a locked state or a released state to a lock/release display lamp 23 that is provided on the instrument panel.

Specifically, the EPB-ECU 9 has various functional portions to perform lock/release control, such as motor current detection that detects a current (motor current) flowing through each motor 10 on an upstream side or a downstream side of the motor 10, target motor current calculation that calculates a target motor current (target current value) for when the lock control is ended, determination as to whether or not the motor current has reached the target motor current, and control of the motors 10 based on an operation state of the operation SW 24. The EPB-ECU 9 causes the motors 10 to rotate in a positive direction or in a reverse direction, or stops the rotation of the motors 10, based on the state of the operation SW 24 and the motor current, thereby performing lock/release control of the EPB 2. Further, the EPB-ECU 9 performs communication by CAN communication or the like with the ESC-ECU 8 and thus acquires, from the ESC-ECU 8, various pieces of information that are used to drive the EPB 2. The acquired information includes failure information indicating that the main braking device, which includes the service brake 1 and the actuator 7, has failed, or information indicating that the negative pressure of the engine has dropped, various pieces of brake information, such as a stroke amount (or stroke change amount) of the brake pedal 3, and information about a pedal depression force. In this way, as well as generating the parking brake force in accordance with a failure mode at a time of a brake failure or when there is a drop in negative pressure, EPB auxiliary control is also performed that controls the parking brake force.

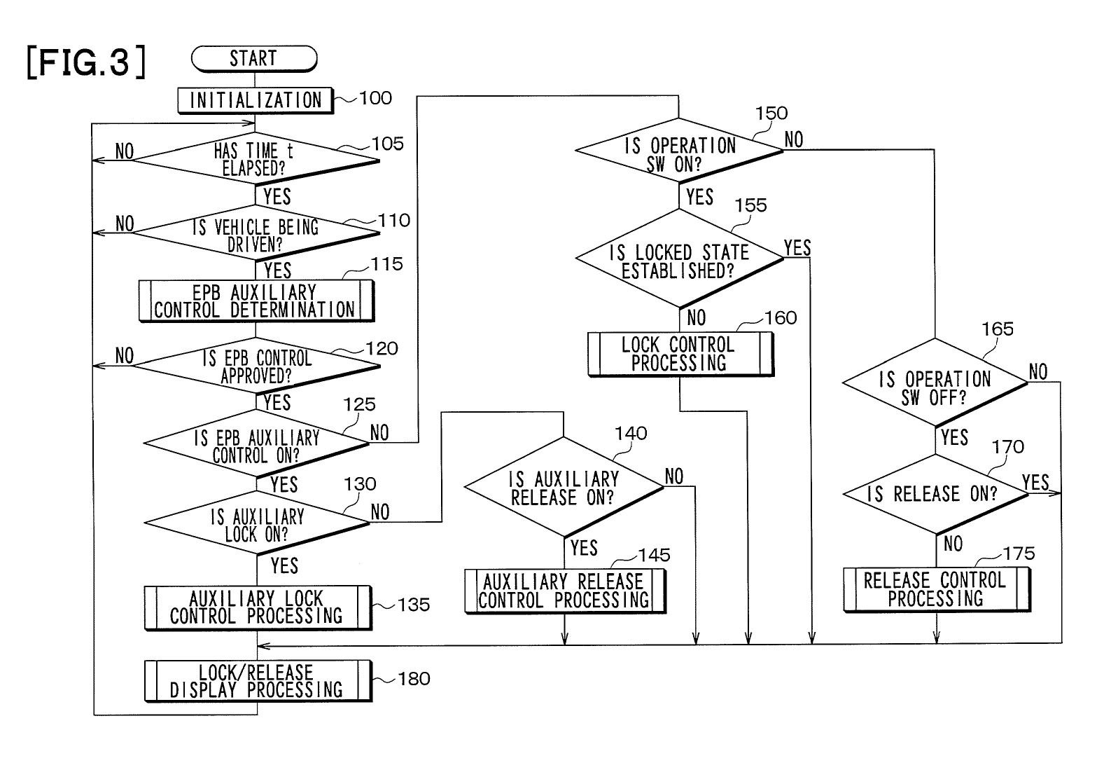

Next, parking brake control will be explained that is performed in accordance with a program stored in an integral ROM, which is not shown in the drawings, by the above-described various functional portions of the EPB-ECU 9 using the brake system configured as described above. FIG. 3 is a flowchart showing, in detail, parking brake control processing.

First, after general initialization processing, such as resetting a time measurement counter and a flag, is performed at step 100, the processing advances to step 105 and a determination is made as to whether or not a time t has elapsed. Here, the time t is a value that prescribes a control period. In other words, by repeating the determination at this step until an elapsed time from when the initialization processing is ended or an elapsed time from a positive determination at this step of the previous control period becomes the time t, the parking brake control is performed each time the time t elapses.

Next, at step 110, a determination is made as to whether or not the vehicle is being driven. Specifically, the determination is made as to whether or not the vehicle is in a state in which it can be driven, based on, for example, whether an ignition switch is turned on or not. When a positive determination is made here, there is a possibility to control the parking brake force and thus the processing advances to the processing from step 105 onwards. When a negative determination is made here, the processing is ended.

At step 115, as EPB auxiliary control determination processing, a determination is made as to whether or not EPB auxiliary control will be performed and as to a manner in which the EPB auxiliary control is to be performed. Specifically, when a target brake force is not generated by the main braking device at a time of a brake failure, the EPB auxiliary control is switched ON and auxiliary lock control is performed to generate a brake force corresponding to an insufficient force based on a lock operation of the EPB 2, or auxiliary release control is performed that causes a release operation of the EPB 2 when releasing or reducing the brake force by the EPB 2. Through this EPB auxiliary control determination processing, as well as setting an auxiliary lock ON that indicates that the auxiliary lock control is to be performed, and an auxiliary release ON that indicates that the auxiliary release control is to be performed, a pattern of the auxiliary lock control is set in accordance with a failure mode, such as a brake failure or a drop in negative pressure.

Then, when the EPB auxiliary control determination processing at step 115 is complete, the processing advances to step 120 and a determination is made as to whether or not the EPB 2 is in an EPB control approval state. The EPB control approval state means a state in which the EPB 2 is able to operate as a system. For example, the EPB-ECU 9 checks whether or not the EPB 2 is in the EPB control approval state by performing an initial check etc., and sets a flag indicating the state. The determination is made based on the flag. When a positive determination is made here, the processing advances to step 125 and onward, and when a negative determination is made, the processing ends directly.

At step 125, a determination is made as to whether or not the EPB auxiliary control is ON. When a positive determination is made here, the processing advances to step 130 and onward, and various processing is performed to execute the EPB auxiliary control. When a negative determination is made, various processing is performed relating to the execution of normal lock/release control.

At step 130, a determination is made as to whether or not the auxiliary lock is ON, namely, whether or not the auxiliary lock control is to be performed. When a positive determination is made, the processing advances to step 135 and the auxiliary lock control processing is performed. Meanwhile, when a negative determination is made, the processing advances to step 140 and a determination is made as to whether or not the auxiliary release is ON, namely, whether or not the auxiliary release control is to be performed. When a positive determination is made, the processing advances to step 145 and the auxiliary release control is performed. When a negative determination is made here also, this indicates a state in which either the auxiliary lock control or the auxiliary release control have been temporarily ended or the like, and the processing advances to step 180.

At step 150, a determination is made as to whether or not the operation SW 24 is ON and a lock request has therefore been issued. The ON state of the operation SW 24 indicates that the driver intends to establish a locked state by actuating the EPB 2. Therefore, when a positive determination is made at this step, the processing advances to step 155, and a determination is made as to whether or not the locked state is established, based on whether or not a lock state flag FLOCK is ON. The lock state flag FLOCK is a flag that is switched ON when the EPB 2 is operated and is in a locked state, and when the lock state flag FLOCK is ON, this indicates that the actuation of the EPB 2 is already complete and a desired brake force is being generated. Thus, when a negative determination is made here, the processing advances to lock control processing at step 160, and when a positive determination is made, the processing advances to step 180 as the lock control processing is already complete.

On the other hand, when a negative determination is made at step 150, the processing advances to step 165 and a determination is made as to whether or not the operation SW 24 has been switched from ON to OFF and a release request has thus been issued. If the operation SW 24 has been switched from ON to OFF, this indicates that the driver intends to cause the EPB 2 to be in a released state from the locked state by actuating the EPB 2. Therefore, when a positive determination is made at this step, the processing advances to step 170 and a determination is made as to whether or not a release state flag FREL is ON. The release state flag FREL is a flag that is switched ON in a state in which the EPB 2 has been actuated and released, namely, a state in which the brake force of the EPB 2 has been released. When the release state flag FREL is ON, this indicates that the operation of the EPB 2 is already complete and the brake force has been released. Thus, the processing advances to release control processing at step 175 only when a negative determination is made here, and when a positive determination is made, the processing advances to step 180 as the release control processing is already complete.

Then, after the auxiliary lock control processing or the auxiliary release control processing, or the lock control processing or the release control processing has ended, lock/release display processing is performed at step 180. In accordance with this type of processing, the parking brake control processing is performed. Hereinafter, each portion of the parking brake control processing will be explained in detail.

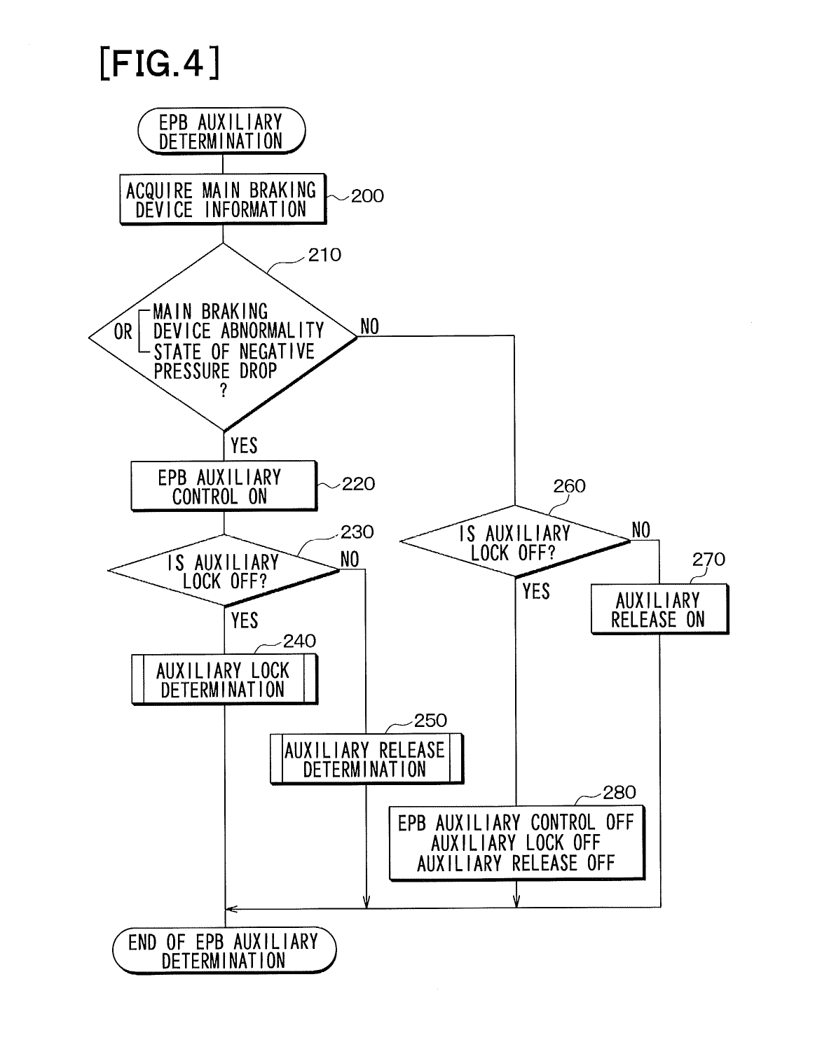

First, the EPB auxiliary control determination processing shown at step 115 in FIG. 3 will be explained. In the EPB auxiliary control determination processing, the determination is made as to whether or not the EPB auxiliary control will be performed and as to the manner in which the EPB auxiliary control is to be performed. FIG. 4 is a flowchart showing, in detail, the EPB auxiliary control determination.

As shown in this drawing, at step 200, main braking device information is acquired, namely, failure information indicating whether the main braking device is normal or is failing. This processing is performed based on communication between the EPB-ECU 9 and the ESC-ECU 8. Then, at step 210, a determination is made as to whether or not an abnormality has occurred in the main braking device or whether or not a negative pressure drop state has occurred. An abnormality in the main braking device means a situation in which a target brake force cannot be generated by the main braking device, due to an abnormality of two piping systems that are included in the service brake 1, an abnormality in the actuator 7 or an abnormality in the booster 4. An abnormality in the piping system may be a single system failure, in which only one of the piping systems experiences an abnormality, or may be a dual system failure in which both the piping systems experience an abnormality. Further, a negative pressure drop state means a state in which an engine negative pressure that is being used by the booster 4 drops due to an engine stop or the like, and a sufficient increase in the pedal depression force cannot be obtained. This case also is a situation in which the target brake force cannot be generated by the main braking device.

Note that, as the negative pressure of the booster 4 is detected by a known negative pressure sensor, it is possible to assume a negative pressure drop state when a negative pressure level becomes equal to or less than a predetermined threshold value. Further, an abnormality in the piping system can be detected based on wheel slip ratio information that is calculated using a detection signal of a wheel speed sensor. For example, even when the brake is applied using the main braking device, a speed of the wheel of the piping system experiencing the failure does not slow down. Thus, based on a comparison between an estimated vehicle body speed and a wheel speed, if there is a piping system for which the wheel speed does not drop with respect to the estimated vehicle body speed during braking, it can be determined that the piping system has failed. As the ESC-ECU 8 detects this type of negative pressure drop state or the abnormality in the main braking device, the determination at this step is made by the EPB-ECU 9 acquiring the information relating to the detection.

Then, if a positive determination is made at step 120, this situation is a situation in which the EPB auxiliary control is necessary. Therefore, the processing advances to step 220 and the EPB auxiliary control is switched ON, thus indicating that the EPB auxiliary control is being executed. Then, the processing advances to step 230, and a determination is made as to whether or not the auxiliary lock is OFF. In this way, the determination is made as to whether to switch to the auxiliary lock control or whether to switch to the auxiliary release control. When a positive determination is made here, the processing advances to step 240 and auxiliary lock determination processing is performed, and when a negative determination is made, the processing advances to step 250 and auxiliary release determination processing is performed.

Meanwhile, when a negative determination is made at step 210, the processing advances to step 260 and a determination is made as to whether or not the auxiliary lock is OFF. When a negative determination is made here, the processing advances to step 270 and the auxiliary release is set to ON. In this way, the processing is ended such that the auxiliary release control processing at the above-described step 145 can be performed. Further, when a positive determination is made here, the processing advances to step 280 and the processing ends, since the EPB auxiliary control is OFF, the auxiliary lock is OFF and the auxiliary release is OFF.

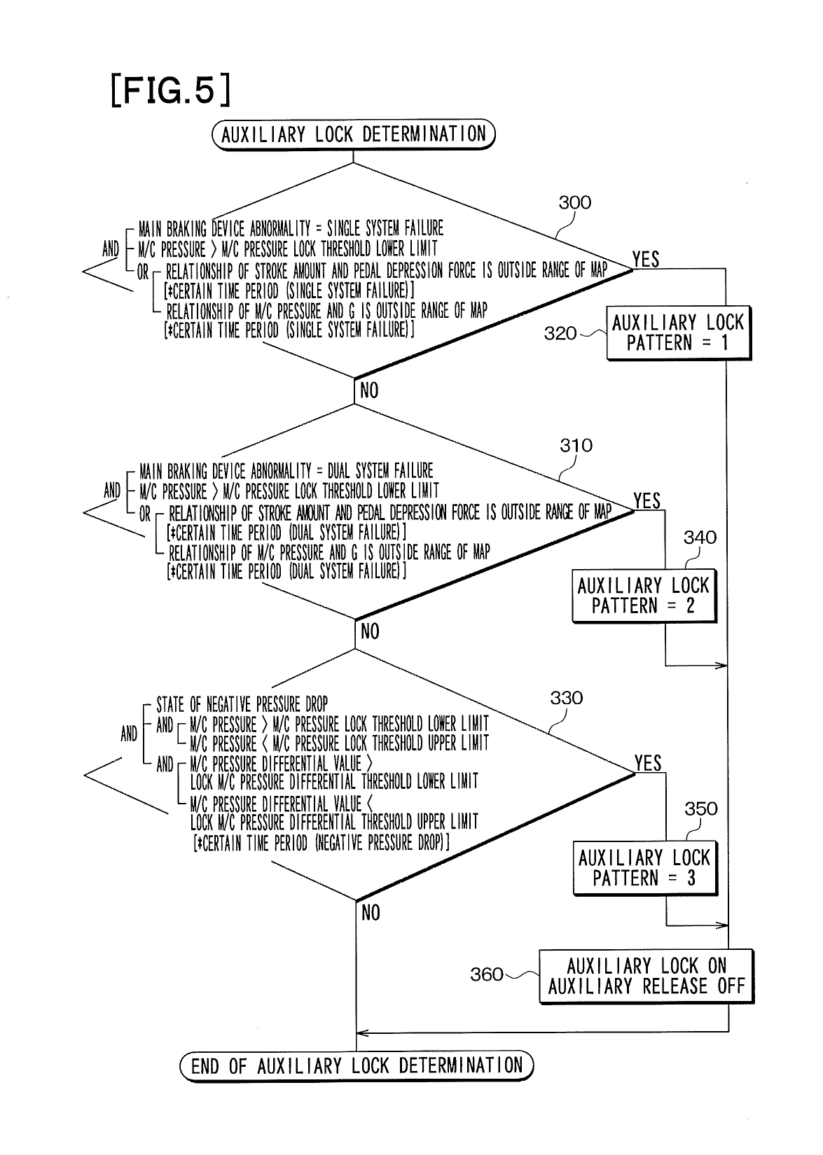

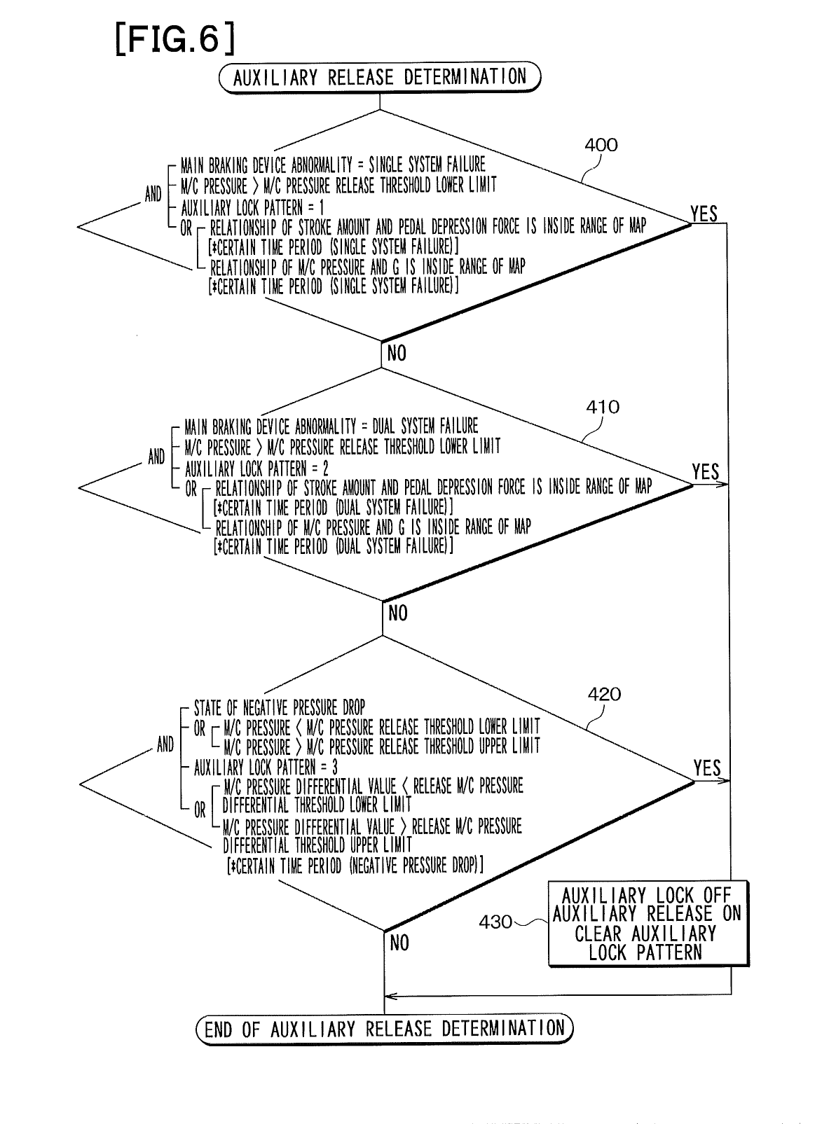

FIG. 5 is a flowchart showing, in detail, the auxiliary lock determination processing performed at the above-mentioned step 240. Further, FIG. 6 is a flowchart showing, in detail, the auxiliary release determination processing performed at the above-mentioned step 250.

In the auxiliary lock determination processing shown in FIG. 5, in addition to identifying the mode of abnormality of the main braking device, a pattern of the auxiliary lock control is set depending on the mode of the abnormality. First, at step 300, a determination is made as to whether or not the mode corresponds to the single system failure. Here, a determination is made as to whether or not information acquired from the ESC-ECU 8 indicates that the abnormality of the main braking device is a single system failure and whether or not the M/C pressure is larger than an M/C pressure lock threshold lower limit. Further, a determination is made as to whether or not a relationship between the stroke amount and the pedal depression force is outside a range of a map or whether or not a relationship between the M/C pressure and a deceleration [G] is outside a range of a map. Each of these conditions is a condition indicating a case in which the abnormality of the main braking device requires the auxiliary lock at a time of a single system failure.

Here, the M/C pressure lock threshold lower limit, which is compared with the M/C pressure, is a threshold value representing the fact that the driver is depressing the brake pedal 3. Even at a time of a brake failure, the M/C pressure is generated similarly as in normal operation when the brake pedal 3 is first depressed. Thus, by comparing the M/C pressure to the M/C pressure lock threshold lower limit, it is possible to verify that the brake pedal 3 is being depressed.

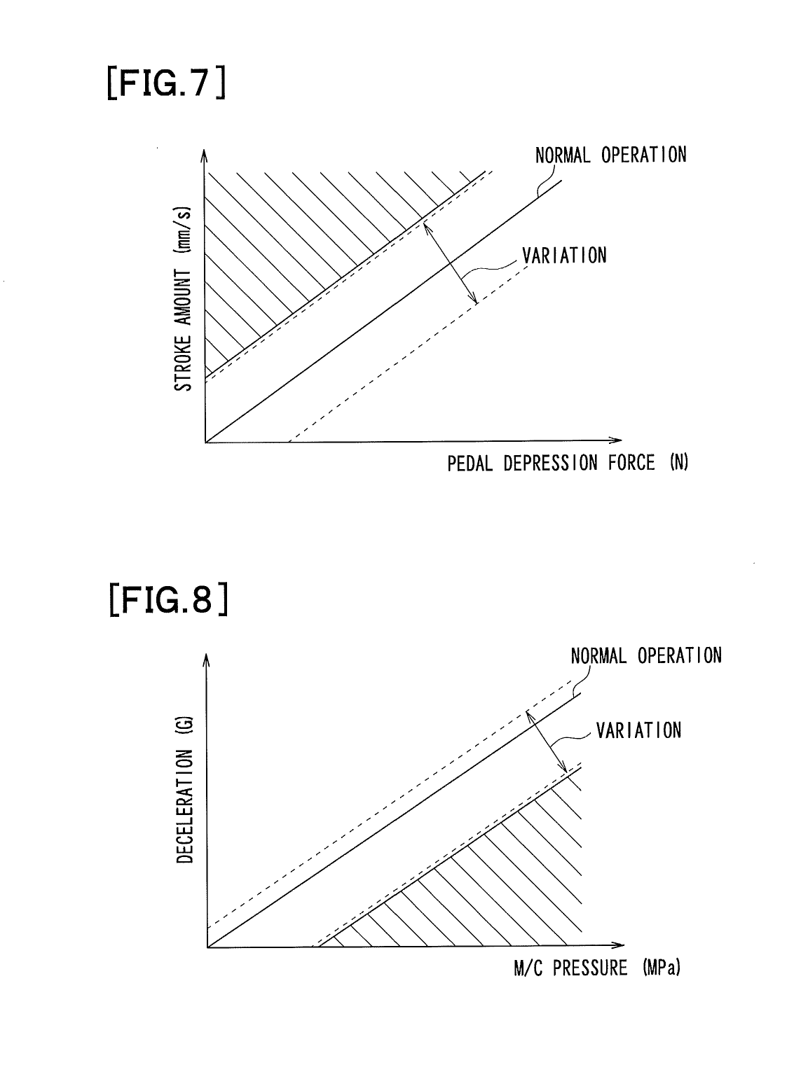

Further, the map showing the relationship between the stroke amount and the pedal depression force is a map showing an assumed relationship between the stroke amount and the pedal depression force at a time of a single system failure in the main braking device. FIG. 7 is a diagram showing an example of the map. During normal operation in which the main braking device is functioning normally, the relationship between the stroke amount and the pedal depression force is a relationship such as that shown by a solid line in the drawing. This relationship can be calculated in advance by investigating, through experimentation etc., a relationship between the stroke amount and the pedal depression force expected from the stroke amount.

However, at a time of a single system failure, a state arises in which the desired pedal depression force cannot be obtained even if the stroke amount is large. Therefore, if the relationship between the stroke amount and the pedal depression force is outside a range that takes variations into consideration with respect to the relationship during normal operation, such as outside a range shown by broken lines in the drawing (namely, if the relationship is within a range in which the pedal depression force cannot be obtained with respect to the stroke amount as shown by a region shaded with diagonal lines in FIG. 7), it is determined that a single system failure has occurred. Here, in order to eliminate noise, it is determined that the auxiliary lock for a single system failure is required when the above-described relationship continues for a certain period of time.

Similarly, the map showing the relationship between the M/C pressure and the deceleration [G] is a map showing an assumed relationship between the M/C pressure and the deceleration [G] at a time of a single system failure in the main braking device. FIG. 8 is a diagram showing an example of the map. During normal operation in which the main braking device is functioning normally, the relationship between the M/C pressure and the deceleration [G] is a relationship such as that shown by a solid line in the drawing. This relationship can also be calculated in advance by investigating, through experimentation etc., a relationship between the M/C pressure and the deceleration [G] expected from the M/C pressure.

However, at a time of a single system failure, a state arises in which the desired deceleration [G] cannot be obtained even if the M/C pressure is large. Therefore, if the relationship between the M/C pressure and the deceleration [G] is outside a range that takes variations into consideration with respect to the relationship during normal operation, such as outside a range shown by broken lines in the drawing (namely, if the relationship is within a range in which the deceleration [G] cannot be obtained with respect to the M/C pressure as shown by a region shaded with diagonal lines in FIG. 8), it is determined that a single system failure has occurred. Here, in order to eliminate noise, it is determined that the auxiliary lock for a single system failure is required when the above-described relationship continues for a certain period of time.

Note that, although, in FIG. 7 and FIG. 8, the range exceeding the range that takes variations into consideration is shown by the region shaded with diagonal lines, a range may be calculated in advance of the assumed relationship between the stroke amount and the pedal depression force, or of the assumed relationship between the M/C pressure and the deceleration [G] at a time of a single system failure. In this case, the determination may be made that a single system failure has occurred if the relationship is within the calculated range.

When a negative determination is made at step 300, the processing advances to step 310, and when a positive determination is made, the processing advances to step 320.

At step 310, by similar processing to that at step 300, a determination is made as to whether or not the mode corresponds to a dual system failure. Here also, the determination is made as to whether or not information acquired from the ESC-ECU 8 indicates that the abnormality of the main braking device is a dual system failure and whether or not the M/C pressure is larger than the M/C pressure lock threshold lower limit. Further, the determination is made as to whether or not the relationship between the stroke amount and the pedal depression force is outside a range of a map or whether or not the relationship between the M/C pressure and the deceleration [G] is outside a range of a map. Each of these conditions is a condition indicating a case in which the abnormality of the main braking device requires the auxiliary lock at a time of a dual system failure.

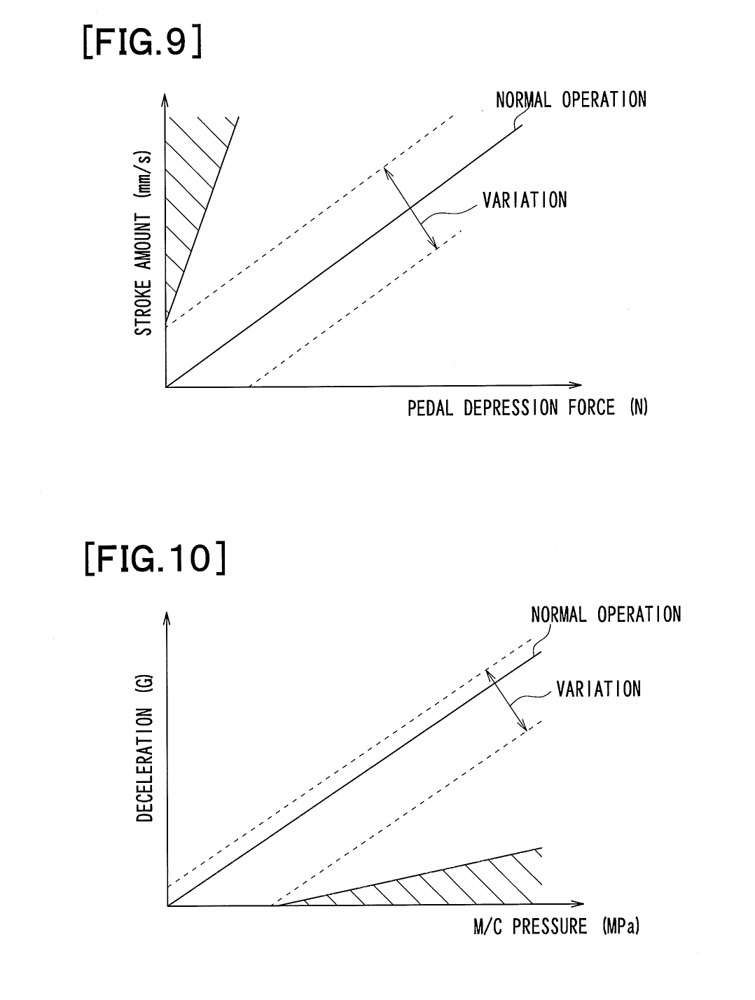

Here, the map showing the relationship between the stroke amount and the pedal depression force is a map showing an assumed relationship between the stroke amount and the pedal depression force when a dual system failure occurs in the main braking device. FIG. 9 is a diagram showing an example of the map. In a similar manner to the occurrence of a single system failure shown in FIG. 7, at a time of a dual system failure, a state arises in which the desired pedal depression force cannot be obtained even when the stroke amount is large. Therefore, if the relationship is within a range in which it is assumed that the pedal depression force cannot be obtained with respect to the stroke amount when a dual system failure occurs, as shown by a region shaded with diagonal lines in FIG. 9, it is determined that a dual system failure has occurred. Compared to the case of a single system failure, in the map for the case of a dual system failure, the pedal depression force that can be obtained with respect to the stroke amount is smaller. In this case also, in order to eliminate noise, it is determined that the auxiliary lock for a dual system failure is required when the above-described relationship continues for a certain period of time.

Similarly, the map showing the relationship between the M/C pressure and the deceleration [G] is a map showing an assumed relationship between the M/C pressure and the deceleration [G] when a dual system failure occurs in the main braking device. In a similar manner to the occurrence of a single system failure shown in FIG. 8, at a time of a dual system failure, a state arises in which the desired deceleration [G] cannot be obtained even when the M/C pressure is large. Therefore, if the relationship is within a range in which it is assumed that the deceleration [G] cannot be obtained with respect to the M/C pressure when a dual system failure occurs, as shown by a region shaded with diagonal lines in FIG. 10, it is determined that a dual system failure has occurred. Compared to the case of a single system failure, in the map for the case of a dual system failure, the deceleration [G] that can be obtained with respect to the M/C pressure is smaller. In this case also, in order to eliminate noise, it is determined that the auxiliary lock for a dual system failure is required when the above-described relationship continues for a certain period of time.

When a negative determination is made at step 310, the processing advances to step 330 and when a positive determination is made, the processing advances to step 340.

At step 330, a determination is made as to whether or not the mode corresponds to a negative pressure drop state. Here, a determination is made as to whether or not information acquired from the ESC-ECU 8 indicates a negative pressure drop state and whether or not the M/C pressure is within a range from the M/C pressure lock threshold lower limit to an M/C pressure lock threshold upper limit. Further, a determination is made as to whether or not a differential value of the M/C pressure is within a range from a lock M/C pressure differential lower limit to a lock M/C pressure differential upper limit. Each of these conditions is a condition indicating a case in which the auxiliary lock is necessary at a time of a negative pressure drop state. The M/C pressure lock threshold upper limit, which is compared with the M/C pressure, is also a threshold value representing the fact that the driver is depressing the brake pedal 3. Further, the lock M/C pressure differential lower limit and the lock M/C pressure differential upper limit, which are compared with the M/C pressure, are also threshold values representing the fact that the driver is depressing the brake pedal 3.

Here, at a time of a negative pressure drop, as it becomes difficult to depress the brake pedal 3, a state arises in which it is difficult to generate the M/C pressure. Therefore, when the brake pedal 3 is depressed when in a negative pressure drop state, the M/C pressure is within the range from the M/C pressure lock threshold lower limit to the M/C pressure lock threshold upper limit. Similarly, the M/C pressure differential value is also within the range from the lock M/C pressure differential lower limit to the lock M/C pressure differential upper limit. Then, in order to eliminate noise, it is determined that the auxiliary lock for a negative pressure drop state is required when the above-described relationship continues for a certain period of time.

When a negative determination is made at step 330, this means that the auxiliary lock is not necessary and the processing ends directly. When a positive determination is made, the processing advances to step 350.

In the above-described manner, when it is determined at step 300, step 310 or step 330 that the auxiliary lock is necessary at a time of a single system failure or dual system failure or at a time of a negative pressure drop state, the processing advances to step 320, step 340 and step 350, respectively, and the auxiliary lock pattern is set in order to perform the auxiliary lock control corresponding to each of the modes of abnormality. In other words, an auxiliary lock pattern 1 is set at a time of a single system failure, an auxiliary lock pattern 2 is set at a time of a dual system failure, and an auxiliary lock pattern 3 is set at a time of a negative pressure drop state. After that, the processing advances to step 360, and as well as switching the auxiliary lock ON in order to perform the auxiliary lock control, the auxiliary release is switched OFF. The auxiliary lock determination processing is completed in this manner.

In the auxiliary release determination processing shown in FIG. 6, at the same time as identifying the mode of the abnormality of the main braking device, the auxiliary release control is performed when the relationship between the stroke amount and the pedal depression force or the relationship between the M/C pressure and the deceleration [G] is in a state of normal operation as a result of the auxiliary lock control.

First, at step 400, a determination is made as to whether or not conditions are satisfied to switch to the auxiliary release control after the auxiliary lock control has been performed at a time of a single system failure. Here, a determination is made as to whether or not information acquired from the ESC-ECU 8 indicates that the abnormality of the main braking device is a single system failure and whether or not the M/C pressure is larger than an M/C pressure release threshold lower limit. Further, when the auxiliary lock pattern 1 is set, a determination is made as to whether or not the relationship between the stroke amount and the pedal depression force is within a range of a map or whether or not the relationship between the M/C pressure and the deceleration [G] is within a range of a map.

Here, the M/C pressure release threshold lower limit, which is compared with the M/C pressure, is a threshold value representing the fact that the driver is depressing the brake pedal 3, and may be the same as the M/C pressure lock threshold lower value, or may be a different value. The auxiliary release control is a control that is performed when the above-described relationships are in a state of normal operation as a result of the auxiliary lock control, and a prerequisite of the auxiliary release control is that a braking operation is being performed. Therefore, it is verified that the brake pedal 3 is being depressed by comparing the M/C pressure and the M/C pressure release threshold lower limit.

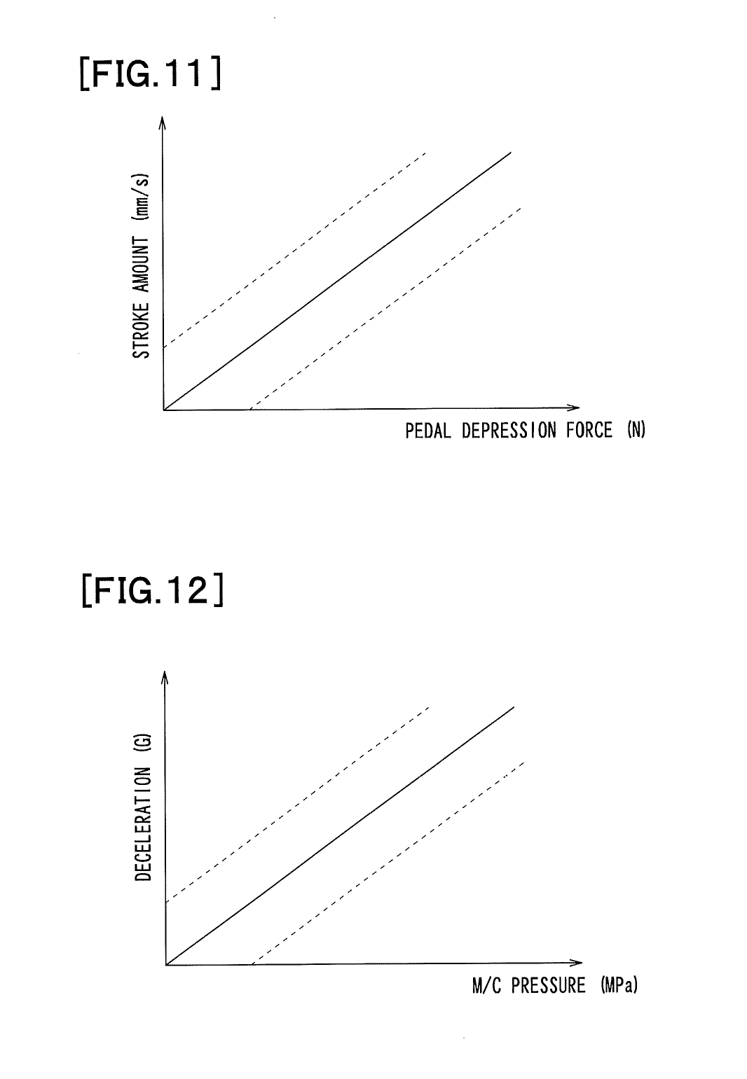

Further, the map showing the relationship between the stroke amount and the pedal depression force is a map showing an example of an assumed relationship between the stroke amount and the pedal depression force when the main braking device is operating normally. FIG. 11 is a diagram showing an example of the map. During normal operation in which the main braking device is functioning normally, the relationship between the stroke amount and the pedal depression force is a relationship such as that shown by a solid line in the drawing, and, even taking variations into consideration, is within a range shown by broken lines. Thus, when the relationship between the stroke amount and the pedal depression force is within the range shown in FIG. 11 as a result of performing the auxiliary lock control at a time of a single system failure, it is determined that the condition to switch to the auxiliary release control is satisfied. Here, in order to eliminate noise, it is determined that the auxiliary release for a single system failure is required when the above-described relationship continues for a certain period of time.

Similarly, the map showing the relationship between the M/C pressure and the deceleration [G] is a map showing an example of an assumed relationship between the M/C pressure and the deceleration [G] when the main braking device is operating normally. FIG. 12 is a diagram showing an example of the map. During normal operation in which the main braking device is functioning normally, the relationship between the M/C pressure and the deceleration [G] is a relationship such as that shown by a solid line in the drawing, and, even taking variations into consideration, is within a range shown by broken lines. Thus, when the relationship between the M/C pressure and the deceleration [G] is within the range shown in FIG. 12 as a result of performing the auxiliary lock control at a time of a single system failure, it is determined that the condition to switch to the auxiliary release control is satisfied. Here, in order to eliminate noise, it is determined that the auxiliary release for a single system failure is required when the above-described relationship continues for a certain period of time.

When a negative determination is made at step 400, the processing advances to step 410 and when a positive determination is made, the processing advances to step 430.

At step 410, a determination is made as to whether or not conditions are satisfied to switch to the auxiliary release control after the auxiliary lock control has been performed at a time of a dual system failure. The conditions are substantially the same as the various conditions at step 400, and the only differing condition is that the auxiliary lock pattern 2 is set instead of the auxiliary lock pattern 1. At a time of a dual system failure also, a switch is made from the auxiliary lock control to the auxiliary release control when the relationship between the stroke amount and the pedal depression force or the relationship between the M/C pressure and the deceleration [G] becomes the relationship that is obtained during normal operation in which the main braking device is functioning normally. Thus, at this step also, when the above-described relationships correspond to the relationships shown in the maps in FIG. 11 and FIG. 12, it is determined that the conditions to switch to the auxiliary release control are satisfied. Here also, in order to eliminate noise, it is determined that the auxiliary release for a dual system failure is required when the above-described relationships continue for a certain period of time.

When a negative determination is made at step 410, the processing advances to step 420 and when a positive determination is made, the processing advances to step 430.

At step 420, a determination is made as to whether or not conditions are satisfied to switch to the auxiliary release control after the auxiliary lock control has been performed at a time of a negative pressure drop state. Here, a determination is made as to whether or not information acquired from the ESC-ECU 8 indicates a negative pressure drop state and whether or not the M/C pressure is lower than the M/C pressure release threshold lower limit or is larger than an M/C pressure release threshold upper limit. Further, a determination is made as to whether or not the M/C pressure differential value is lower than a release M/C pressure differential lower limit or is higher than a release M/C pressure differential upper limit. Each of these conditions is a condition indicating a case in which the auxiliary release is necessary at a time of a negative pressure drop state. The M/C pressure release threshold upper limit, which is compared with the M/C pressure, is also a threshold value representing the fact that the driver is depressing the brake pedal 3, and may be the same value as the M/C pressure lock threshold upper limit or may be a different value. Further, the release M/C pressure differential lower limit and the release M/C pressure differential upper limit, which are compared with the M/C pressure differential value, are also threshold values representing the fact that the driver is depressing the brake pedal 3. The release M/C pressure differential lower limit and the release M/C pressure differential upper limit may also be the same values as the lock M/C pressure differential lower limit and the lock M/C pressure differential upper limit, respectively, or they may be different values.

At a time of a negative pressure drop, as it is difficult to depress the brake pedal 3, it is difficult to generate the M/C pressure. However, when a state is achieved in which the desired M/C pressure is generated as a result of the auxiliary lock control, a switch may be made to the auxiliary release control. Thus, the M/C pressure is lower than the M/C pressure release threshold lower limit or higher than the M/C pressure release threshold upper limit. Similarly, the M/C pressure differential value is lower than the release M/C pressure differential lower limit or higher than the release M/C pressure differential upper limit. Further, in order to eliminate noise, it is determined that the auxiliary release for a negative pressure drop state is required when the above-described relationship continues for a certain period of time.

When a negative determination is made at step 420, this means that the auxiliary release is not necessary and the processing ends directly, and when a positive determination is made, the processing advances to step 430.

In the above-described manner, when it is determined at step 400 to step 420 to be a case in which the switch is made from the auxiliary lock control to the auxiliary release control at a time of a single system failure, a dual system failure or a negative pressure drop state, the processing advances to step 430 and the auxiliary lock is switched OFF in order to perform the auxiliary release control. At the same time, the auxiliary release is switched ON and the auxiliary lock pattern is cleared. The auxiliary release determination processing is completed in this manner. Further, the auxiliary lock determination processing and the auxiliary release determination processing shown at step 240 and step 250 in FIG. 4 are completed, and the EPB auxiliary determination shown at step 115 in FIG. 3 is thus completed.

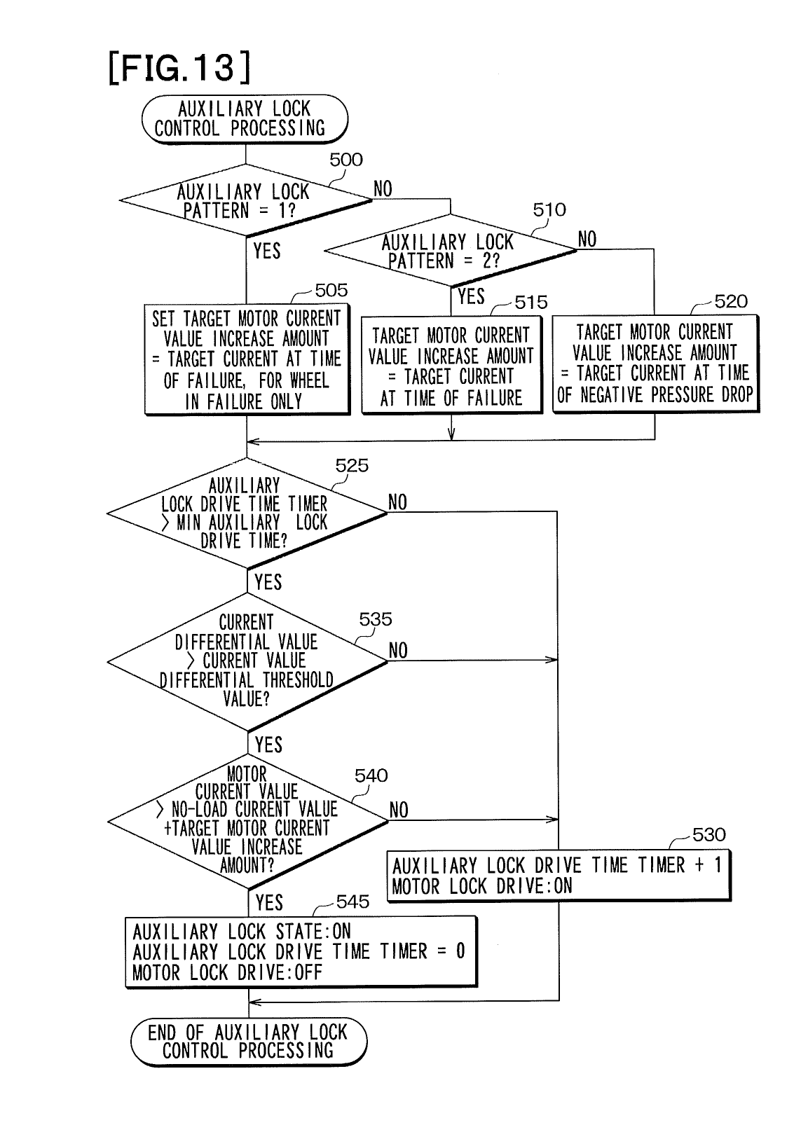

Next, the auxiliary lock control processing shown at step 135 in FIG. 3 will be explained. In the auxiliary lock control processing, the parking brake force is caused to be generated, in accordance with content of the set auxiliary lock pattern (auxiliary lock patterns 1 to 3), when it is determined that the auxiliary lock is necessary due to an abnormality in the main braking device in the above-described auxiliary lock determination processing. FIG. 13 is a flowchart showing, in detail, the auxiliary lock control processing.

First, at step 500, a determination is made as to whether or not the auxiliary lock pattern 1 has been set. A positive determination is made when the auxiliary lock pattern 1 has been set at the above-described step 320, and a negative determination is made when another of the auxiliary lock patterns has been set. When the positive determination is made here, the processing advances to step 505, and a target motor current value increase amount is set as a target current when a failure occurs. The target motor current value increase amount is set for a failing wheel only, and, in comparison to a wheel that is not failing, a brake force resulting from the parking brake force is added for the failing wheel.

The target motor current value increase amount is an amount of increase in the motor current corresponding to the target brake force. Specifically, it is the amount of increase of the motor current from a no-load current value. The motor current flowing through each of the motors 10 fluctuates depending on the load applied to the motor 10. In the case of the present embodiment, since the load applied to the motor 10 corresponds to the pressing force that presses the brake pads 11 against the brake disc 12, it has a value that corresponds to the pressing force generated by the motor current. Thus, a value obtained by adding the target motor current value increase amount to the no-load current value is the target motor current necessary to generate the target brake force. As a result, the target motor current value increase amount is set, by the auxiliary lock control, as the target current at a time of failure, and, by adding the target motor current value increase amount to the no-load current value, it is possible to set the target motor current such that the parking brake force corresponding to a single system failure can be generated.

Meanwhile, when a negative determination is made at step 500, the processing advances to step 510 and a determination is made as to whether or not the auxiliary lock pattern 2 is set. A positive determination is made if the auxiliary lock pattern 2 is set at the above-described step 340, and a negative determination is made if the auxiliary lock pattern 3 is set at the above-described step 350. When the positive determination is made here, the processing advances to step 515 and the target current at a time of failure is set as the target motor current value increase amount. In this case, as a dual system failure has occurred, this is set for the wheels on both systems. By the auxiliary lock control setting the target current at a time of failure as the target motor current value increase amount in this way, it is possible to set the target motor current such that the parking brake force corresponding to a dual system failure can be generated.

It should be noted that a common calculation method can be used to calculate the target current at a time of failure (=the target motor current value increase amount) for both a single system failure and a double system failure. For example, the calculation can be based on Formula 1. Note, also, that a required braking torque (per wheel) [Nm] in Formula 1 is calculated using Formula 2.

Target current at time of failure [A]=(required braking torque (per wheel) [Nm]/(2×pad μ×braking effective radius [m]/1000)×braking torque conversion efficiency [%]×axial force current conversion factor [N→A] (Formula 1)

Required braking torque (per wheel) [Nm]=(target deceleration at time of failure [G]−output deceleration [G])×tire diameter [m]×vehicle weight [kg]/2 (Formula 2)

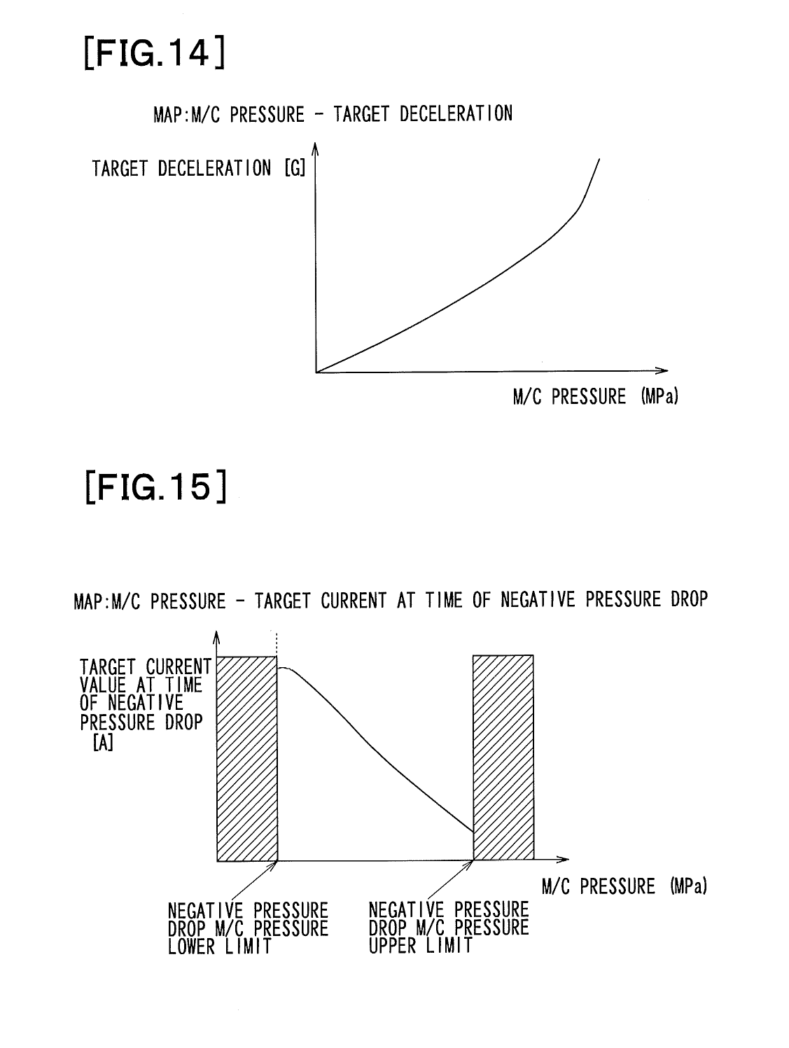

Note that the pad μ (a coefficient of friction of the brake pad), the braking effective radius and the axial force current conversion factor are values unique to each vehicle. The braking torque conversion efficiency is a value suitable for each vehicle that can change with temperature. Further, the target deceleration at a time of failure is calculated using a map shown in FIG. 14 that shows a relationship between the M/C pressure (MPa) and a target deceleration [G]. This map shows the relationship in which the target deceleration increases the more the M/C pressure increases. This map also shows a value suitable for each vehicle. The target deceleration at a time of failure is a deceleration that should be obtained, intrinsically, when a failure is not occurring, and a deviation between the target deceleration at a time of failure and a deceleration being output is an amount of deceleration that cannot be obtained due to the failure. The required braking torque is calculated such that the amount of deceleration that cannot be obtained is generated as the parking brake force.

Further, when a negative determination is made at step 510, the processing advances to step 520 and a target current at a time of a negative pressure drop is set as the target motor current value increase amount. In this case, as the influence of the negative pressure drop is affecting all the wheels, the target current at a time of a negative pressure drop is set for all the wheels provided with the EPB 2. By the auxiliary lock control setting the target current at a time of a negative pressure drop as the target motor current value increase amount in this manner, it is possible to set the target motor current such that the parking brake force corresponding to a negative pressure drop state can be generated.

Note that the target current at a time of a negative pressure drop (=target motor current value increase amount) is calculated using a relationship between the M/C pressure (MPa) and a target current value at a time of a negative pressure drop [A] that is shown in FIG. 15. This map shows the relationship in which the target current value at a time of a negative pressure drop decreases the more the M/C pressure increases. This map also shows a value suitable for each vehicle. When a negative pressure drop occurs, it is desired to obtain a certain deceleration, and thus the target current value at a time of a negative pressure drop is set with respect to the M/C pressure. The target current value at a time of a negative pressure drop increases as the M/C pressure decreases, and an added amount of the brake force resulting from the parking brake force increases.

The processing then advances to step 525, and a determination is made as to whether or not an auxiliary lock drive time timer has exceeded a minimum (MIN) auxiliary lock drive time that is set in advance. The auxiliary lock drive time timer is a timer that measures an elapsed time period from a start of the auxiliary lock control, and starts measurement simultaneously with the start of the auxiliary lock control processing. The minimum auxiliary lock drive time is a minimum time period that is assumed to be necessary for the auxiliary lock control, and is decided in advance in accordance with a rotation speed of the motors 10 etc. During an initial period of the auxiliary lock control, a rush current may occur, and if the rush current reaches the target motor current, it may be mistakenly determined that the desired parking brake force has been generated even though it has not been generated. So that the above-described mistaken determination does not occur, a period until the auxiliary lock drive time timer exceeds the minimum auxiliary lock drive time is masked.

When a negative determination is made here, the processing advances to step 530, the auxiliary lock drive time timer is incremented by one and a motor lock drive is switched ON. In this manner, in order to perform the auxiliary lock control at least during the period until the auxiliary lock drive time exceeds the minimum auxiliary lock drive time, each corresponding motor 10 is caused to rotate in a positive direction. In this way, the spur gear 15 is driven in accordance with the positive rotation of the motor 10, the spur gear 16 and the rotation shaft 17 are rotated, and the meshing between the male screw groove 17a and the female screw 18a causes the propeller shaft 18 to move to the brake disc 12 side. As a result of this, the piston 19 is also caused to move in the same direction, thus causing the brake pads 11 to move to the brake disc 12 side.

Meanwhile, when a positive determination is made at step 525, the processing advances to step 535 and a current value differential value is calculated by differentiating the motor current with respect to time. For example, a difference between the motor current obtained in the present control cycle and the motor current obtained in the previous control cycle is used as the current value differential value. Then, a determination is made as to whether or not the current value differential value is larger than a current value differential threshold.

The motor current fluctuates depending on the load applied to the motor 10. For example, in the case of the present embodiment, since the load applied to the motor 10 corresponds to the pressing force that presses the brake pads 11 against the brake disc 12, it has a value that corresponds to the pressing force generated by the motor current. Therefore, when the motor 10 is in the no-load state, the motor current is the no-load current value, and when a load is applied to the motor 10, the motor current starts to rise.

Thus, by calculating the current value differential value by differentiating the motor current with respect to time, it is possible to detect changes in the motor current, and by comparing the current value differential value with the current value differential threshold, it is possible to detect when the motor current starts to rise. Note that the current value differential threshold is set as a value at which it is assumed that the motor current starts to rise, while eliminating fluctuations of the motor current due to noise. Therefore, when a positive determination is made at step 535, the processing advances to step 540 and when a negative determination is made, the processing advances to step 530 and the above-described processing is performed.

At step 540, a determination is made as to whether or not the motor current has exceeded a value obtained by adding the target motor current value increase amount to the no-load current value, namely, whether or not the motor current has exceeded the target motor current. As described above, the motor current fluctuates depending on the load applied to the motor 10, and so, in the case of the present embodiment, since the load applied to the motor 10 corresponds to the pressing force that presses the brake pads 11 against the brake disc 12, it has a value that corresponds to the pressing force generated by the motor current. Therefore, if the motor current exceeds the target motor current, a state is obtained in which the desired parking brake force is generated by the generated pressing force. In other words, a state is obtained in which a friction-applying surface of each of the brake pads 11 is pressed against an internal wall surface of the brake disc 12 with a certain amount of force by the EPB 2. As a result, the processing at step 530 is repeated until a positive determination is made at this step, and when a positive determination is made, the processing advances to step 545.

At step 545, an auxiliary lock state is switched to ON, which indicates that the auxiliary lock operation is complete. At the same time, the auxiliary lock drive time timer is set to zero and a motor lock drive is switched OFF (stopped), as an auxiliary lock maintaining operation. In this way, the rotation of the motor 10 is stopped and the rotation of the rotation shaft 17 is stopped. The propeller shaft 18 is held in the same position due to the frictional force caused by the meshing between the male screw groove 17a and the female screw groove 18a, and the parking brake force generated at that time is maintained. The movement of the parked vehicle is regulated in this manner. The auxiliary lock control processing is ended in this manner.

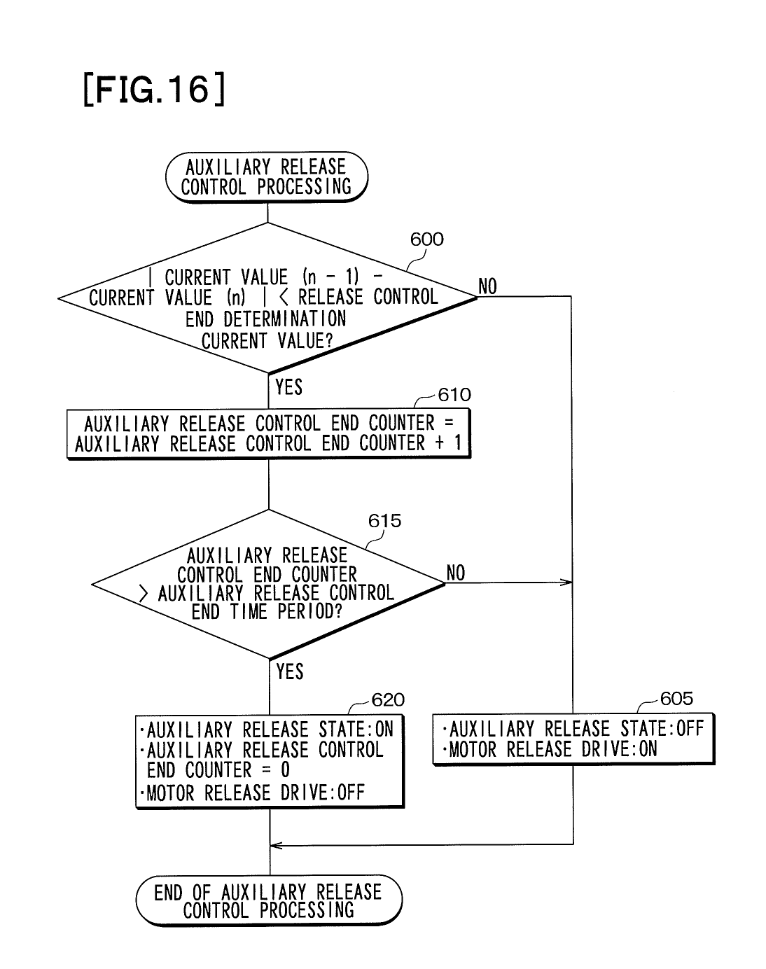

Next, the auxiliary release control processing shown at step 145 in FIG. 3 will be explained. In the auxiliary release control processing, the parking brake force generated by the EPB 2 at the time of the auxiliary lock control is released by the above-described auxiliary release determination processing. FIG. 16 is a flowchart showing, in detail, the auxiliary release control processing.

First, at step 600, a determination is made as to whether or not an absolute value|current value (n−1)−current value (n)|of a difference between a current value (n−1) of the motor current detected at the previous control cycle and a current value (n) of the motor current detected at the present control cycle is less than a release control end determination current value.

As described above, the motor current fluctuates depending on the load applied to the motor 10, and when the pressing force that presses the brake pads 11 against the brake disc 12 no longer exists, the motor current becomes constant at the no-load current value and no longer fluctuates. For that reason, the release control end determination current value is set as a current change amount at which it is assumed that the load on the motor 10 no longer exists. Thus, when the absolute value|current value (n−1)−current value (n)|becomes less than the release control end determination current value, it is determined that the brake pads 11 are separated from the brake disc 12 and that there is no longer a load on the motor 10.

Therefore, when a negative determination is made at step 600, the processing advances to step 605 and an auxiliary release state is switched to OFF. At the same time, a motor release drive is switched ON, namely, the motor 10 is caused to rotate in the reverse direction. In this manner, in accordance with the reverse rotation of the motor 10, the brake pads 11 are caused to move in a direction that separates them from the brake disc 12.

When a positive determination is made at step 600, the processing advances to step 610 and, after an auxiliary release control end counter is incremented, the processing advances to step 615. At step 615, a determination is made as to whether or not the auxiliary release control end counter has exceeded an auxiliary release control end time period.

The auxiliary release control end time period is a period of time during which the auxiliary release control is continued from a timing at which the load on the motor 10 no longer exists, namely, a timing at which the brake pads 11 have been separated from the brake disc 12. The greater the amount that the brake pads 11 have been moved by the motor 10 at the time of the auxiliary lock control, the longer the auxiliary release control end time period becomes.

Here, when the auxiliary release control end counter has not exceeded the auxiliary release control end time period, this means that the auxiliary release control is still continuing, and the processing at step 605 is performed. Then, when the auxiliary release control end counter exceeds the auxiliary release control end time period, the processing advances to step 620 and the auxiliary release state is switched to ON. At the same time, the auxiliary release control end counter is set to zero, and the motor release drive is switched OFF. Thus, the rotation of the motor 10 is stopped, and the brake pads 11 are held in the state of being separated from the brake disc 12. The auxiliary release control processing is ended in this manner.

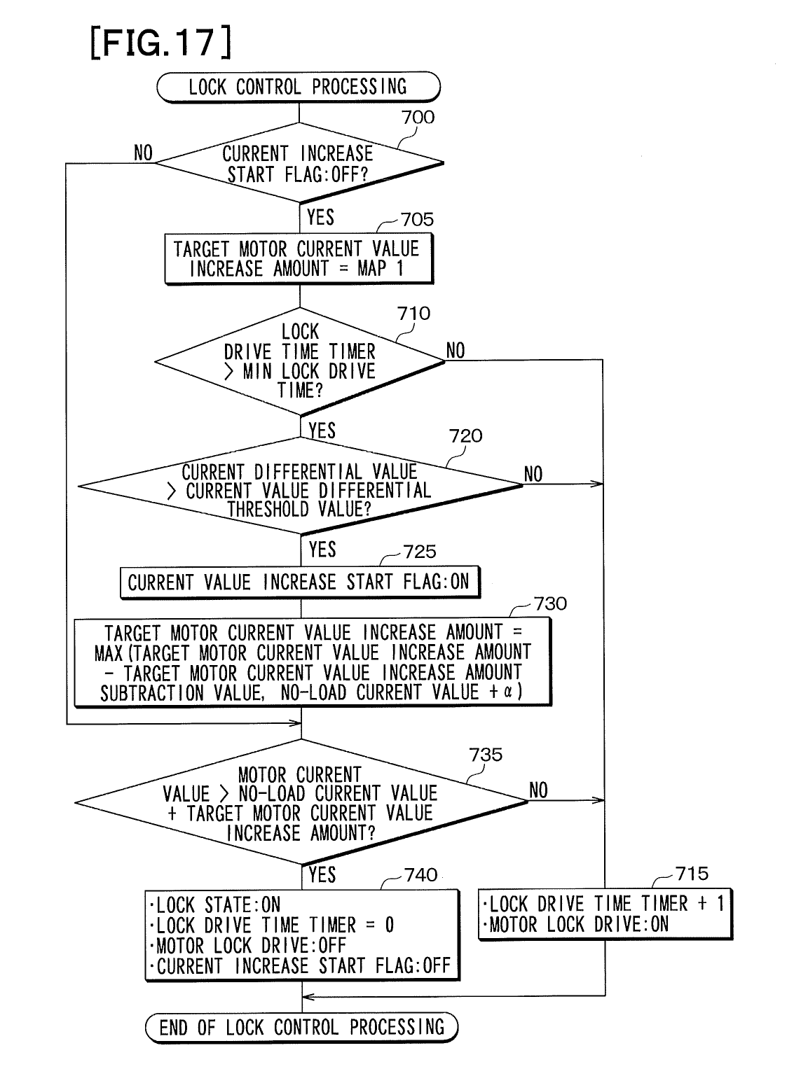

Next, the lock control processing shown at step 160 in FIG. 3 will be explained. In the lock control processing, processing is performed as follows. The EPB 2 is activated by rotating the motors 10, in response to a request from the driver to activate the EPB 2, namely, in response to the operation of the operation SW 24. The rotation of each motor 10 is stopped at a position at which the desired parking brake force is generated by the EPB 2, and that state is maintained. FIG. 17 shows a flowchart showing, in detail, the lock control processing, and the lock control processing will be explained with reference to this drawing.

First, at step 700, a determination is made as to whether or not a current value increase start flag is OFF. The current value increase start flag is a flag that is switched ON when the motor current starts to rise, and is OFF until it is switched ON at step 725, which will be explained later. When a positive determination is made here, the processing advances to step 705.

At step 705, a target motor current value increase amount that is required to generate the parking brake force by the lock operation is set. In principle, the target motor current value increase amount referred to here is also the increase amount of the motor current from the no-load current value, and the value that is obtained by adding the target motor current value increase amount to the no-load current value is the target motor current that is necessary to generate the target brake force. The target motor current value increase amount at that time may be set to be equal to or higher than an increase amount of the motor current that generates the W/C pressure corresponding to the minimum brake force necessary to maintain a parked state.

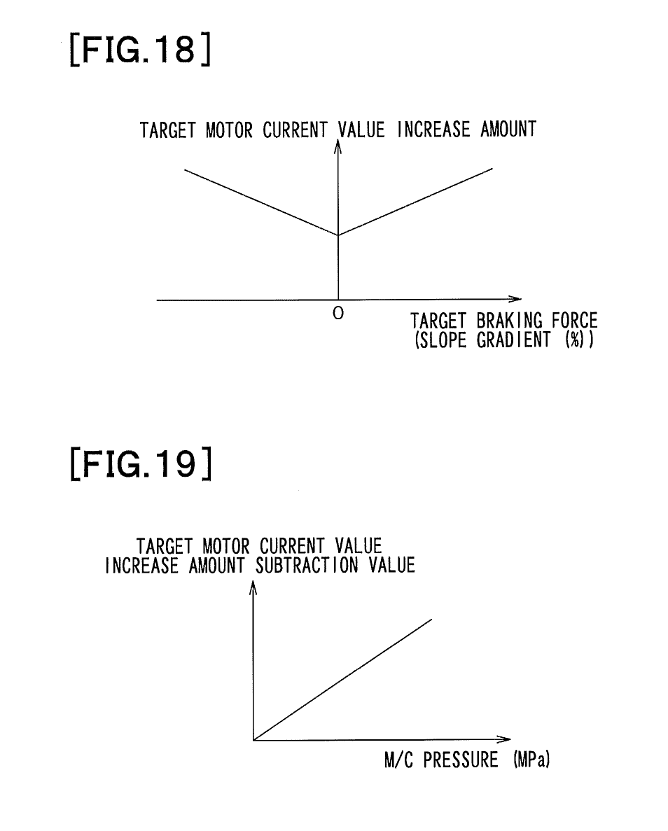

Here, a relationship between the W/C pressure corresponding to the target brake force and the target motor current value increase amount is mapped, and the target motor current value increase amount corresponding to the target brake force is acquired using the map. FIG. 18 is a map showing an example of the above relationship. The map in FIG. 18 shows that the target motor current value increase amount becomes larger proportionally with the magnitude of the W/C pressure corresponding to the target brake force. Note that the target brake force is the brake force necessary to maintain the vehicle in a stopped state, and is a value that is decided in accordance with a slope gradient, and the relationship may be mapped such that the target motor current value increase amount becomes larger proportionally with the slope gradient. As the slope gradient is represented by a value of the G sensor 25, the target motor current value increase amount may be set based on the value of the G sensor 25.

Next, the processing advances to step 710, and a determination is made as to whether or not a lock drive time timer has exceeded a minimum (MIN) lock drive time that is set in advance. The lock drive time timer is a timer that measures an elapsed time period from a start of the lock control, and starts measurement simultaneously with the start of the lock control processing. The minimum lock drive time is a minimum time period that is assumed to be necessary for the lock control, and is decided in advance in accordance with the rotation speed of the motors 10 etc. As at step 735, which will be explained later, a determination is made as to whether or not the brake force generated by the EPB 2 has reached a desired value at a time at which the motor current reaches the value that is obtained by adding the target motor current value increase amount to the no-load current value. However, it is also possible that the motor current may exceed that value due to a rush current etc. that occurs when an electric current is initially supplied to the motors 10. Therefore, by comparing the lock drive time timer with the minimum lock drive time, the initial period of the control can be masked, and it is possible to prevent a mistaken determination as a result of a rush current or the like.

Therefore, if the lock drive time timer has not exceeded the minimum lock drive time, this means that the lock control is still continuing and the processing advances to step 715. At step 715, the lock drive time timer is incremented and the motor lock drive is switched ON, namely, the motors 10 are caused to rotate in the positive direction. In this way, in accordance with the positive rotation of the motors 10, the brake pads 11 are caused to move to the brake disc 12 side and the lock operation by the EPB 2 is performed.

When a positive determination is made at step 710, the processing advances to step 720 and a current value differential value is calculated by differentiating the motor current with respect to time. For example, a difference between the motor current obtained in the present control cycle and the motor current obtained in the previous control cycle is used as the current value differential value. Then, a determination is made as to whether or not the current value differential value is larger than a current value differential threshold. This processing is substantially the same as the processing at step 535 shown in FIG. 13 of the auxiliary lock control processing.

Then, when a positive determination is made at step 720, the current value increase start flag, which indicates that the motor current has started to increase, is switched ON at step 725 and the processing advances to step 730. When a negative determination is made at step 720, this means that there is still no load applied to the motors 10, and so the processing at step 715 is once more performed.

Next, at step 730, as processing that takes into account an amount of brake force being generated by the service brake 1, the target motor current value increase amount is corrected. Specifically, when the brake force is being generated by the service brake 1, correction is performed to make the target motor current value increase amount smaller, by calculating a target motor current value increase amount subtraction value for the target motor current value increase amount, by which the target motor current value increase amount is made smaller in correspondence with the magnitude of the brake force. Then, a value is calculated by subtracting the target motor current value increase amount subtraction value from the target motor current value increase amount calculated at step 705.

In the present embodiment, a value of the target motor current value increase amount subtraction value corresponding to the M/C pressure is mapped, and the target motor current value increase amount subtraction value is calculated based on the resulting map, by extracting a value corresponding to the M/C pressure detected by the M/C pressure sensor 26. FIG. 19 is a map showing an example of the above, and is a map showing a relationship between the M/C pressure and the target motor current value increase amount subtraction value. As shown in this drawing, the map shows that the target motor current value increase amount subtraction value becomes larger proportionally with the magnitude of the M/C pressure, namely, the magnitude of the depression (the pedal depression force) of the brake pedal 3 by the driver. As a result, in the case of the present embodiment, the target motor current value increase amount subtraction value corresponding to the detected M/C pressure is read out from the map shown in FIG. 19, and then the target motor current value increase amount subtraction value is subtracted from the target motor current value increase amount, thus calculating the target motor current value increase amount.

It should be noted here that it is not preferable for the target motor current value increase amount to be zero or lower. Therefore, at step 730, of the value obtained by subtracting the target motor current value increase amount subtraction value from the target motor current value increase amount and a value that is obtained by adding a predetermined value α (a positive constant) to the no-load current value, the larger value (MAX (target motor current value increase amount−target motor current value increase amount subtraction value, no-load current value+α)) is used as the target motor current value increase amount.

After that, the processing advances to step 735 and a determination is made as to whether or not the motor current has exceeded the value obtained by adding the target motor current value increase amount to the no-load current value, namely, whether or not the motor current has exceeded the target motor current. When the motor current exceeds the value obtained by adding the target motor current value increase amount to the no-load current value, the state is obtained in which the desired parking brake force is generated by the generated pressing force. Specifically, the state is obtained in which the friction-applying surface of each of the brake pads 11 is pressed against the internal wall surface of the brake disc 12 with a certain amount of force by the EPB 2. As a result, the processing at step 715 is repeated until a positive determination is made at this step, and when a positive determination is made, the processing advances to step 740.

Then, at step 740, the lock state is switched to ON, which indicates that the lock operation is complete. At the same time, the lock drive time timer is set to zero and the motor lock drive is switched OFF (stopped). In this way, the rotation of the motors 10 is stopped and the brake force generated at that time is maintained. The movement of the parked vehicle is regulated in this manner. Further, the current value increase start flag is switched OFF. The lock control processing is completed in this manner.

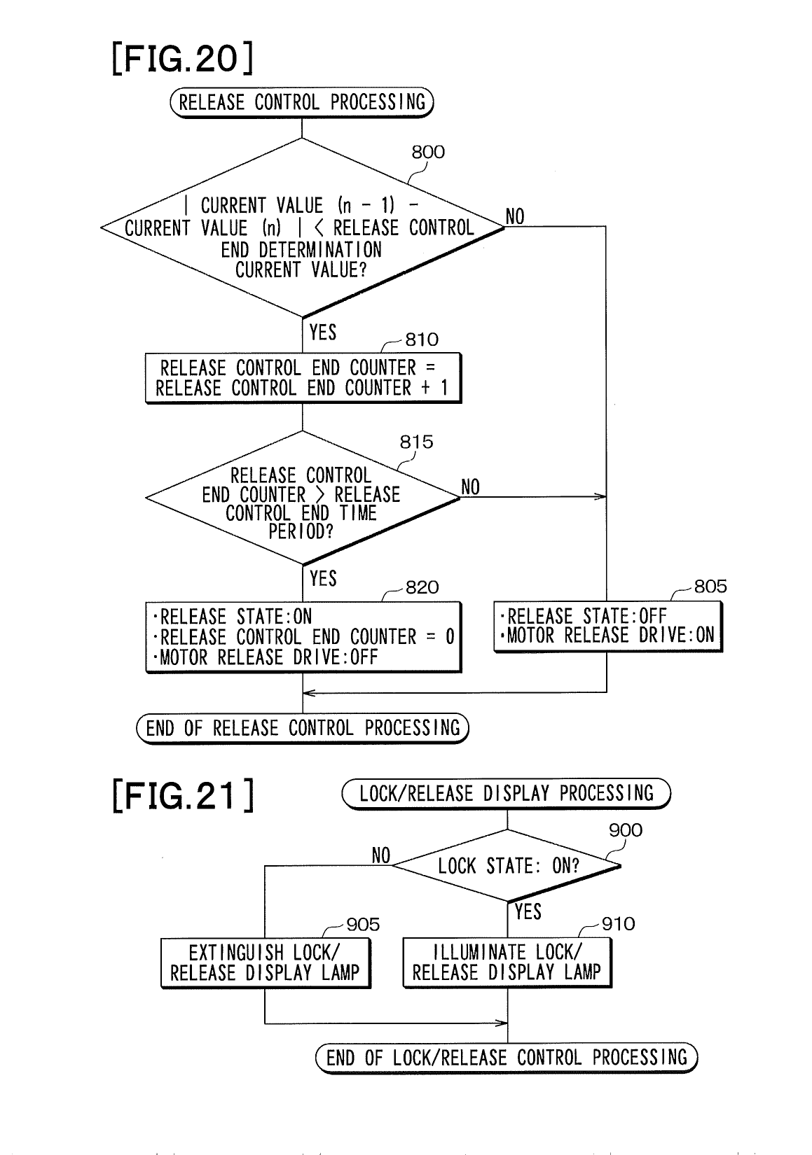

Next, the release control processing shown at step 175 in FIG. 3 will be explained. In the release control processing, the EPB 2 is activated by causing the motors 10 to rotate, and processing is performed to release the parking brake force being generated by the EPB-ECU 9. FIG. 20 shows a flowchart showing, in detail, the release control processing, and the release control processing will be explained with reference to this drawing.

First, at step 800, a determination is made as to whether or not the absolute value|current value (n−1)−current value (n)|of the difference between the current value (n−1) of the motor current detected in the previous control cycle and the current value (n) of the motor current detected in the present control cycle is less than the release control end determination current value. This processing is substantially the same as the processing at step 600 shown in FIG. 16 of the above-described auxiliary release control processing.

When a negative determination is made at step 800, the processing advances to step 805 and the release state is set to OFF. At the same time, the motor release drive is switched ON, namely, the motors 10 are caused to rotate in the reverse direction. In this way, in accordance with the reverse rotation of the motors 10, the brake pads 11 are caused to move in a direction of separation from the brake disc 12. Further, when a positive determination is made at step 800, the processing advances to step 810 and, after incrementing a release control end counter, the processing advances to step 815. At step 815, a determination is made as to whether or not the release control end counter has exceeded a release control end time period.

The release control end time period is a period of time during which the release control is continued from a timing at which the load on the motors 10 disappears, namely, a timing at which the brake pads 11 have been separated from the brake disc 12. The greater the amount that the brake pads 11 have been moved by the motors 10 at the time of the lock control, the longer the release control end time period becomes. This processing is substantially the same as the processing at step 615 shown in FIG. 16 of the above-described auxiliary release control processing.

Here, when the release control end counter has not exceeded the release control end time period, this means that the release control is still continuing, and the processing at step 805 is performed. Then, when the release control end counter exceeds the release control end time period, the processing advances to step 820 and the release state is switched to ON. At the same time, the release control end counter is set to zero, and the motor release drive is switched OFF. Thus, the rotation of the motors 10 is stopped, and the brake pads 11 are held in the state of being separated from the brake disc 12. The release control processing is ended in this manner.

Finally, lock/release display processing, shown at step 180 in FIG. 3, will be explained. In the lock/release display processing, the lock state or the release state is displayed. FIG. 21 shows a flowchart showing, in detail, the lock/release display processing and the lock/release display processing will be explained with reference to this drawing.

At step 900, a determination is made as to whether or not the lock state is ON. When a negative determination is made here, the processing advances to step 905 and the lock/release display lamp 23 is extinguished, and when a positive determination is made, the processing advances to step 910 and the lock/release display lamp 23 is illuminated. In this way, when the lock state is switched to ON and it is the lock state, the lock/release display lamp 23 is illuminated and when the release state is switched to ON, namely, it is the release state or the state in which the release control has been started, the lock/release display lamp 23 is extinguished. In this way, it is possible for the driver to recognize whether or not it is the lock state. The lock/release display processing ends in this manner and the parking brake control processing ends accordingly.

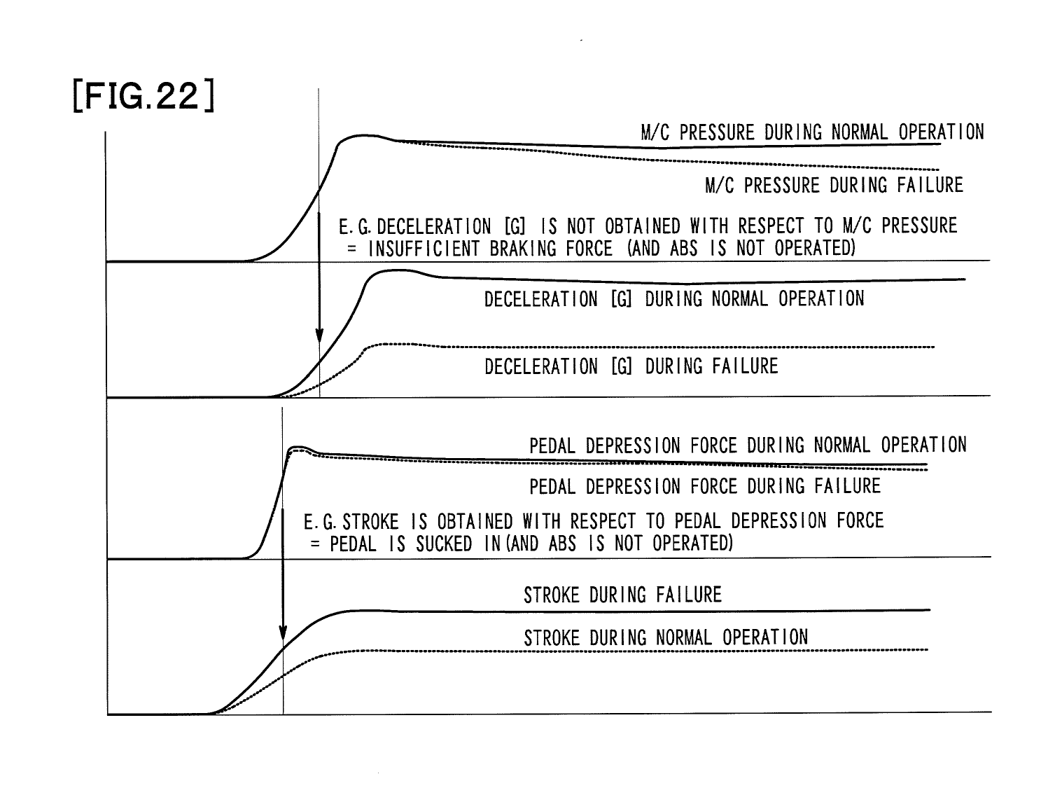

Next, operation of the parking brake control processing according to the present embodiment will be explained with reference to timing charts shown in FIG. 22 to FIG. 27.

FIG. 22 is a timing chart illustrating processing at a time of a brake failure. At a time of a brake failure, when it is attempted to generate the same pedal depression force as in normal operation in which a brake failure has not occurred, the M/C pressure is not generated and a reactive force cannot be obtained. Thus, the stroke is larger at a time of a brake failure, compared to at a time of normal operation. Also, at a time of a brake failure, if the brake pedal 3 is depressed until the same pedal depression force is generated as in normal operation, the M/C pressure that is close to that of normal operation can be generated, but even if the M/C pressure has been generated, the deceleration [G] that can be obtained at a time of a brake failure is smaller compared to that obtained at a time of normal operation. In addition, the difference between the M/C pressure at a time of normal operation and the M/C pressure at a time of a brake failure is small when the brake pedal is initially depressed, but the difference gradually becomes larger as time elapses.

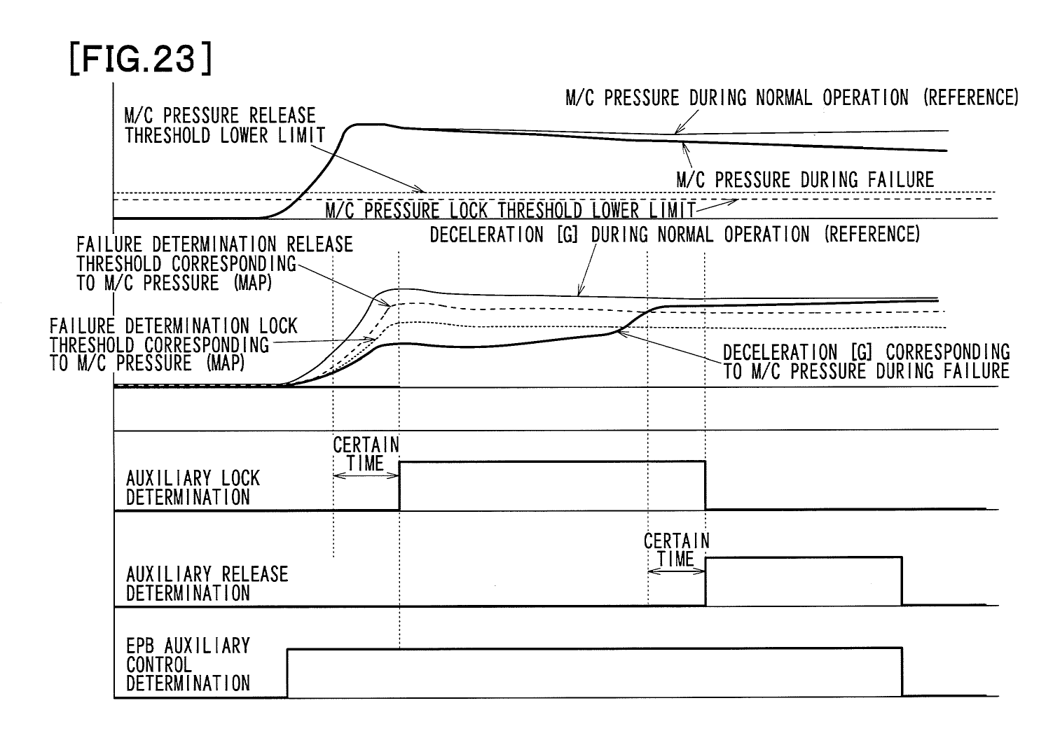

FIG. 23 is a timing chart showing, as processing at a time of a brake failure, the EPB auxiliary control that is performed when the deceleration [G] is not obtained with respect to the M/C pressure, namely, in a case of insufficient brake force. In this drawing, the range in which the deceleration [G] is not obtained with respect to the M/C pressure and which is shown by the region shaded with diagonal lines in FIG. 8, is represented as a failure determination lock threshold that corresponds to the M/C pressure. Further, the range of the M/C pressure and the deceleration [G] in FIG. 12 that is assumed when the main braking device is operating normally is represented as a failure determination release threshold that corresponds to the M/C pressure.

As shown in this drawing, at a time of a brake failure, in the EPB auxiliary control determination, it is determined that the EPB auxiliary control is ON. Then, if a state continues for a certain period of time in which the M/C pressure lock threshold lower limit is exceeded at a time of a brake failure, and the deceleration [G] corresponding to the obtained M/C pressure is lower than the failure determination lock threshold that corresponds to the M/C pressure, the auxiliary lock is switched ON as a result of the auxiliary lock determination. Then, if the deceleration [G] with respect to the M/C pressure recovers due to the auxiliary lock control, and if a state continues for a certain period of time in which the deceleration [G] corresponding to the obtained M/C pressure is higher than the failure determination release threshold that corresponds to the M/C pressure, the auxiliary release is switched ON as a result of the auxiliary release determination. In this manner, the auxiliary lock control is performed that generates the lacking brake force based on the lock operation of the EPB 2, or the auxiliary release control is performed that causes a release operation of the EPB 2 when the brake force by the EPB 2 is released or is reduced. In this way, even at a time of a brake failure, it is possible to obtain the desired deceleration [G] that corresponds to the M/C pressure.

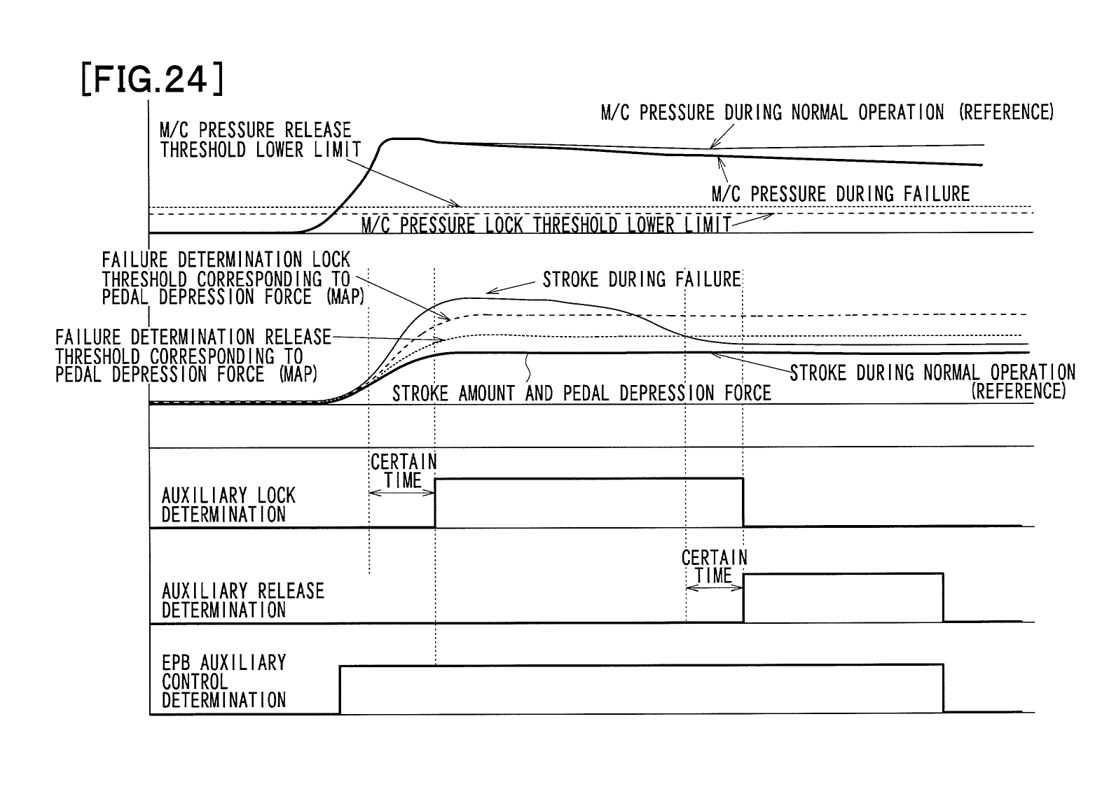

FIG. 24 is a timing chart showing, as processing at a time of a brake failure, the EPB auxiliary control that is performed when the stroke is obtained with respect to the pedal depression force, namely, when the brake pedal 3 is being sucked in. In this drawing, the range in which the pedal depression force is not obtained with respect to the stroke amount and which is shown by the region shaded with diagonal lines in FIG. 7, is represented as a failure determination lock threshold that corresponds to the pedal depression force. Further, the range of the stroke amount and the pedal depression force in FIG. 11 that is assumed when the main braking device is operating normally is represented as a failure determination release threshold that corresponds to the pedal depression force.

As shown in this drawing, at a time of a brake failure, in the EPB auxiliary control determination, it is determined that the EPB auxiliary control is ON. Then, if a state continues for a certain period of time in which the M/C pressure lock threshold lower limit is exceeded at a time of a brake failure, and the stroke corresponding to the obtained pedal depression force is higher than the failure determination lock threshold that corresponds to the pedal depression force, the auxiliary lock is switched ON as a result of the auxiliary lock determination. Then, when the stroke corresponding to the pedal depression force recovers after the auxiliary lock control, if a state continues for a certain period of time in which the stroke corresponding to the obtained pedal depression force is lower than the failure determination release threshold that corresponds to the pedal depression force, the auxiliary release is switched ON as a result of the auxiliary release determination. In this way, even at a time of a brake failure, it is possible to inhibit the brake pedal 3 from being sucked in, and to obtain the desired stroke corresponding to the pedal depression force.

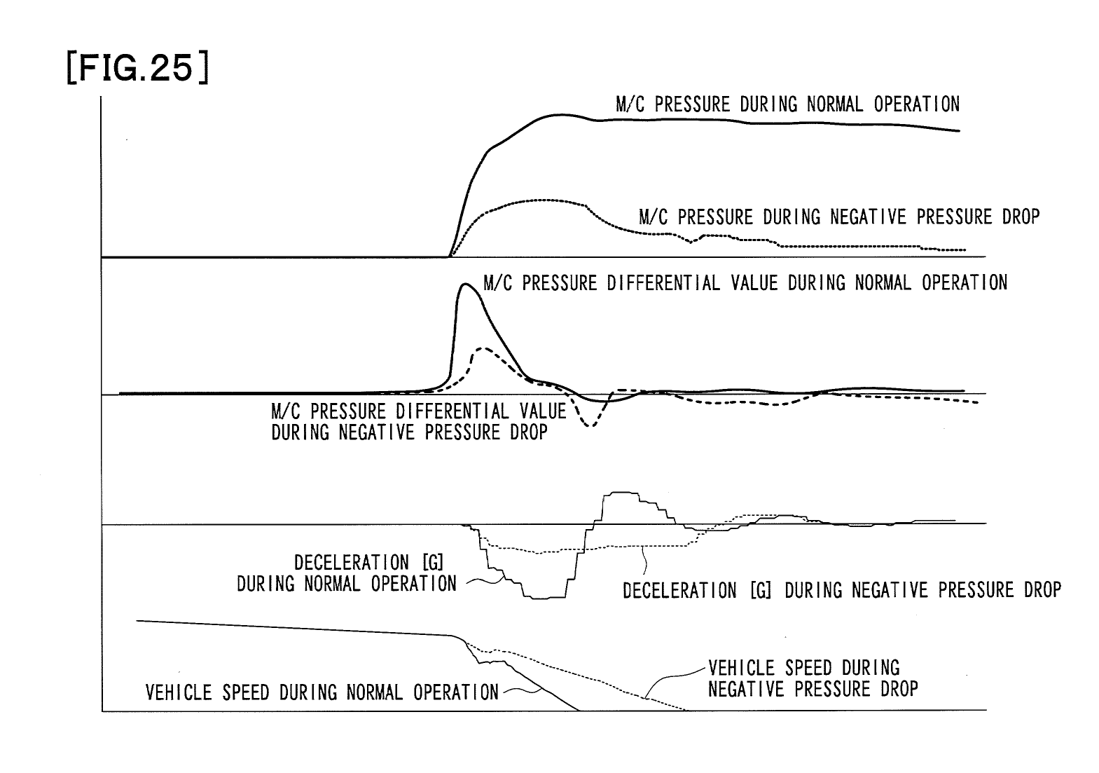

FIG. 25 is a timing chart illustrating processing at a time of a negative pressure drop state. At a time of a negative pressure drop state, even if the brake pedal 3 is depressed using a similar pedal depression force to that in normal operation in which a negative pressure drop state does not exist, the generated M/C pressure is smaller than that in normal operation. Similarly, at a time of a negative pressure drop state, the M/C pressure differential value is also smaller in comparison to that in normal operation. Further, as the M/C pressure generated at a time of a negative pressure drop state is smaller, the deceleration [G] obtained at a time of a negative pressure drop state is also smaller in comparison to that in normal operation. Thus, at a time of a negative pressure drop state, a reduction in the vehicle speed is slower than that in normal operation, and a braking distance becomes longer.

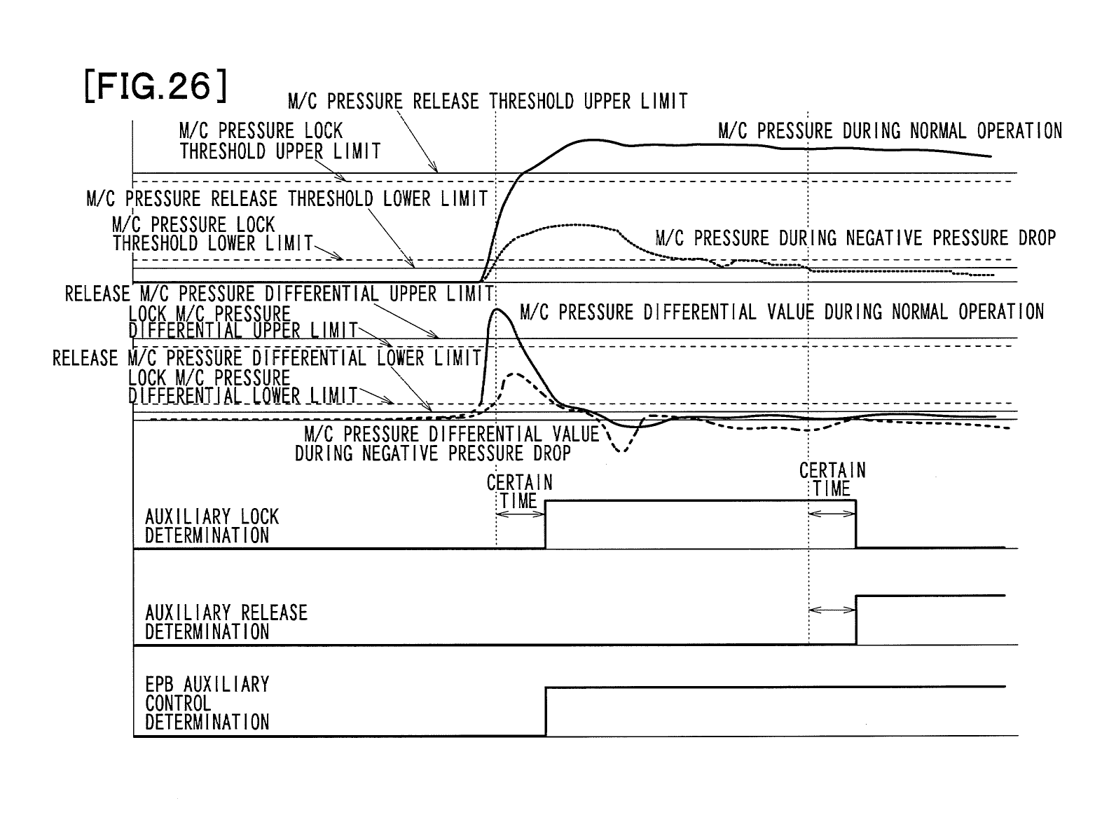

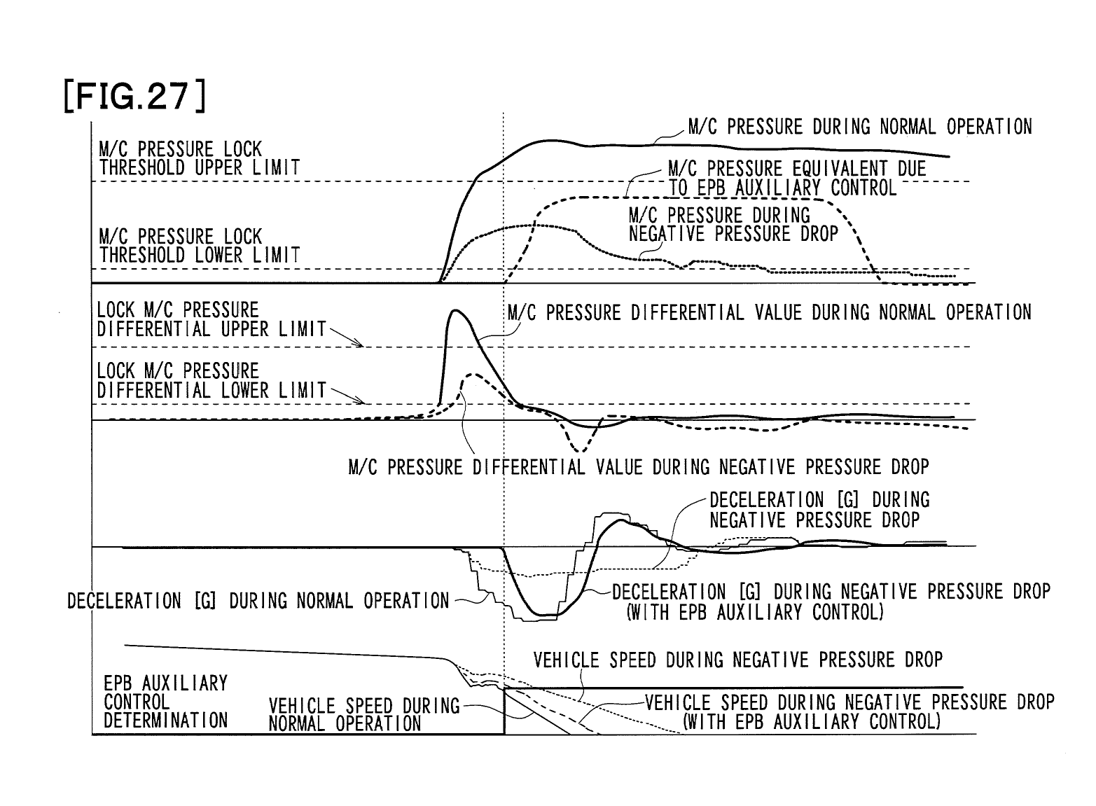

FIG. 26 and FIG. 27 are timing charts respectively showing a case in which the EPB auxiliary control is performed at a time of a negative pressure drop state.

As shown in FIG. 26, at a time of a negative pressure drop state, in the EPB auxiliary control determination, it is determined that the EPB auxiliary control is ON. Then, if a state continues for a certain period of time in which the M/C pressure at a time of a negative pressure drop state is within the range between the M/C pressure lock threshold lower limit and the M/C pressure lock threshold upper limit, and the M/C pressure differential value is within the range between the M/C pressure differential lower limit and the M/C pressure differential upper limit, the auxiliary lock is switched ON as a result of the auxiliary lock determination. Then, by performing the auxiliary lock control, a brake force equivalent to the difference between the M/C pressure at a time of normal operation and the M/C pressure at a time of a negative pressure drop state is generated, as shown in FIG. 27, and it is thus possible to generate the desired deceleration [G] even in a negative pressure drop state.

After that, when a state continues for a certain period of time in which the M/C pressure is equal to or lower than the M/C pressure release threshold lower limit or is equal to or higher than the M/C pressure release threshold upper limit, or when the M/C pressure differential value is equal to or lower than the release M/C pressure differential lower limit or is equal to or higher than the release M/C pressure differential upper limit, the auxiliary release is switched ON as a result of the auxiliary release determination. In this manner, the auxiliary lock control is performed that generates the lacking brake force based on the lock operation of the EPB 2, or the auxiliary release control is performed that causes a release operation of the EPB 2 when the brake force by the EPB 2 is released or is reduced. In this way, even at a time of a negative pressure drop state, it is possible to obtain the desired deceleration [G].

As described above, in the present embodiment, when there is an abnormality or a negative pressure drop state in the main braking device, the auxiliary lock control is performed that generates the lacking brake force based on the lock operation of the EPB 2, or the auxiliary release control is performed that causes a release operation of the EPB 2 when the brake force by the EPB 2 is released or is reduced. Then, the wheel on which the auxiliary lock control is to be performed, and the parking brake force to be generated by the auxiliary lock control are set, depending on the mode of failure determined by the auxiliary lock determination. As a result, even when there is an abnormality or a negative pressure drop state in the main braking device, the desired brake force can be reliably generated. Further, as the desired brake force can be generated, it is possible to obtain the desired deceleration [G].

Further, at a time of a brake failure on one system only, as the brake force is insufficient on the wheel of that system, yaw caused by the insufficient brake force can occur. However, by generating the parking brake force using the EPB 2, it is possible to generate the brake force on the wheel of the failed system also, and to compensate for the brake force that is lacking on the wheel of the failed system. It is thus possible to cause the brake force to act in a direction that suppresses the occurrence of yaw. In this manner, it is possible to perform braking while more reliably maintaining the stability of the vehicle.

### Other Embodiments

In the above-described embodiment, at step 300 and step 310 shown in FIG. 5, the determination is made as to whether or not the relationship between the stroke amount and the pedal depression force is outside the range of the map, and the determination is made as to whether or not the relationship between the M/C pressure and the deceleration [G] is outside the range of the map. If a positive determination is made in either determination, it is determined to be a brake failure. Further, the same determinations are made at step 400 and step 410 shown in FIG. 6. At each of these steps, a format may be adopted in which only one of each of the conditions is determined. Of course, by performing the determination for both the conditions, more reliable control can be performed. However, if the relationship between the stroke amount and the pedal depression force is not determined, for example, a benefit can be obtained in that an expensive stroke sensor is not required.

Further, at step 300 and step 310 shown in FIG. 5, a brake failure is detected, using the map showing the relationship between the M/C pressure and the deceleration [G], when the state outside the normal range continues over a certain period of time. However, a brake failure can be detected using another method. For example, by comparing outputs of wheel speed sensors on different systems, a single system failure may be determined for a system that has a slow reduction in the wheel speed output. Further, a dual system failure may be determined when a state continues for a certain period of time in which there is no difference in the wheel speed of all the wheels, as indicated by the wheel speed sensors, even when braking is being performed, and the deceleration [G] detected by the G sensor 25 does not attain a certain value or more.

In addition, in the above-described embodiment, the auxiliary lock control and the auxiliary release control are performed at a time of a brake failure or at a time of a negative pressure drop state, but the auxiliary lock control and the auxiliary release control may be performed only at a time of a brake failure or only at a time of a negative pressure drop state.

Further, in the above-described embodiment, the example is given of the vehicle brake system to which the present invention is applied, but modifications can be made to each of the portions provided in the vehicle brake system as applicable.

For example, in the above-described embodiment, the M/C pressure is detected by the M/C pressure sensor 26, but, if ABS control etc. is not being operated, as the W/C pressure is substantially equivalent to the M/C pressure, the pressure of a W/C pressure sensor may be detected. In other words, the determination of a brake failure and a negative pressure drop state may be performed using pressure detection values of portions that can perform pressure detection in the piping provided in the vehicle brake system.

Further, in the above-described embodiment, the vehicle brake system in which the brake pedal 3 is used as a brake operating member is explained, but the present invention can be applied even when another brake operating member, such as a brake lever, is used. Specifically, as long as it is a vehicle brake system in which an operating force of the brake operating member is boosted by the booster 4 that uses the negative pressure of the engine, and the W/C pressure is generated based on the boosted operating force, the configuration of the vehicle brake system is not limited to that of the above-described embodiment.

For example, the steps shown in each of the drawings correspond to means for performing various types of processing. For example, of the EPB-ECU 9, a portion that performs the processing at the above-described step 115 to step 145 corresponds to auxiliary control means, a portion that performs the processing at step 135 corresponds to auxiliary lock control processing means, a portion that performs the processing at step 145 corresponds to auxiliary release control processing means, a portion that performs the processing at step 210 corresponds to abnormality determination means, a portion that performs the processing at step 240 corresponds to auxiliary lock determination means, and a portion that performs the processing at step 250 corresponds to auxiliary release determination means.

### REFERENCE SIGNS LIST

1 . . . Service brake

2 . . . EPB 2

3 . . . Brake pedal

4 . . . Booster

5 . . . M/C

7 . . . Actuator

8 . . . ESC-ECU

9 . . . EPB-ECU

10 . . . Motor

11 . . . Brake pad

12 . . . Brake disc

13 . . . Caliper

24 . . . Operation SW

25 . . . G sensor

26 . . . M/C pressure sensor

1. A parking brake control device adopted in a vehicle brake system including a main braking device and a parking brake device,
wherein: the main braking device includes a service brake and an actuator, the service brake boosting an operating force of a brake operating member using a booster based on an engine negative pressure and generating a master cylinder pressure inside a master cylinder based on the boosted operating force, while also generating a brake force for each of wheels by generating, based on the master cylinder pressure, a wheel cylinder pressure in a wheel cylinder of each of the wheels that are connected, respectively, to two systems of brake lines; the actuator controls the wheel cylinder pressure of the service brake; and
the parking brake device electrically generating a parking brake force, the parking brake control device comprising:
auxiliary control means for executing auxiliary control in which auxiliary lock control that controls the parking brake device and generates a parking brake force and auxiliary release control that releases the parking brake force are performed, and thus a target brake force in accordance with an operation amount of the brake operating member is generated using the brake force generated by the main braking device and the parking brake force;
wherein
the auxiliary control means includes
abnormality determination means for determining whether an abnormality is occurring in the main braking device,
auxiliary lock determination means for determining, when an abnormality is determined by the abnormality determination means, whether the abnormality is a single system failure in which one system of the two systems has failed or a dual system failure in which both systems of the two systems have failed, and for determining whether to execute the auxiliary lock control that generates the parking brake force by controlling the parking brake device,
auxiliary release determination means for determining, after the auxiliary lock control, whether to execute the auxiliary release control that releases the parking brake force generated by the auxiliary lock control,
auxiliary lock control processing means for setting, in accordance with a mode of failure determined by the auxiliary lock determination means, a wheel on which the auxiliary lock control is to be executed and the parking brake force to be generated by the auxiliary lock control, and
auxiliary release control processing means for executing the auxiliary release control that releases the parking brake force generated by the auxiliary lock control, based on the determination of the auxiliary release determination means.

2. The parking brake control device according to claim 1, wherein
when the failure determined by the auxiliary lock determination means is the single system failure, the auxiliary lock control processing means sets the parking brake force to be generated by the parking brake device provided on a wheel of the system on which the failure is detected, and
when the failure determined by the auxiliary lock determination means is the dual system failure, the auxiliary lock control processing means sets the parking brake force to be generated by the parking brake device provided on wheels of both the systems.

3. The parking brake control device according to claim 1, wherein
the auxiliary lock determination means determines the single system failure and the dual system failure by determining whether one of a relationship between a stroke amount and the operating force of the brake operating member and a relationship between the master cylinder pressure and a deceleration of the vehicle is outside a predetermined range that is established based on a relationship assumed in normal operation in which the single system failure has not occurred, or whether the one of the relationships is outside a predetermined range that is established based on a relationship assumed in normal operation in which the dual system failure has not occurred.

4. The parking brake control device according to claim 3, wherein
the auxiliary release determination means determines that the auxiliary release control is to be executed when one of the relationship between the stroke amount and the operating force of the brake operating member and the relationship between the master cylinder pressure and the deceleration of the vehicle is within the predetermined range established based on the relationship assumed in normal operation in which the single system failure has not occurred, or when the one of the relationships is within the predetermined range that is established based on the relationship assumed in normal operation in which the dual system failure has not occurred.

5. The parking brake control device according to claim 1, wherein
the abnormality determination means determines, as one of the abnormalities, whether an engine negative pressure that is used by the booster drops and is in a negative pressure drop state, and
the auxiliary lock determination means determines that, when it is determined by the abnormality determination means that a negative pressure drop state exists, the auxiliary lock control is to be executed when the master cylinder pressure is within a range between a predetermined lock threshold lower limit and a lock threshold upper limit, and a differential value of the master cylinder pressure is within a range between a predetermined lock differential threshold lower limit and a lock differential threshold upper limit.

6. The parking brake control device according to claim 5, wherein
the auxiliary release determination means determines that the auxiliary release control is to be executed when the master cylinder pressure is lower than the predetermined lock threshold lower limit or higher than the lock threshold upper limit, and the differential value of the master cylinder pressure is lower than the predetermined lock differential threshold lower limit or higher than the lock differential threshold upper limit.

7. The parking brake control device according to claim 1, wherein
when the failure determined by the auxiliary lock determination means is the single system failure, the auxiliary lock control processing means generates a parking brake force for a wheel of the system on which the failure is detected by using the parking brake device, and
when the failure determined by the auxiliary lock determination means is the dual system failure, the auxiliary lock control processing means generates a parking brake force for wheels of both the systems by using the parking brake device.
